(19) United States
(12) Patent Application Publication
(10) Pub. No.: US 2015/0368481 A1
(43) Pub. Date: Dec. 24, 2015

(54) METHOD FOR IMPROVED STABILITY OF LAYER-BY-LAYER ASSEMBLIES FOR MARINE ANTIFOULING PERFORMANCE WITH A NOVEL POLYMER

(71) Applicants: AGENCY FOR SCIENCE, TECHNOLOGY AND RESEARCH, Connexis, Singapore (SG); NATIONAL UNIVERSITY OF SINGAPORE, Singapore (SG)

(72) Inventors: Xiaoying Zhu, Singapore (SG); Dominik Janczewski, Singapore (SG); Julius G. Vancso, Singapore (SG); Lay Ming Serena Teo, Singapore (SG); Chin Sing Lim, Singapore (SG); Siew Chen Serina Lee, Singapore (SG)

(21) Appl. No.: 14/764,446

(22) PCT Filed: Jan. 30, 2014
(86) PCT No.: PCT/SG2014/000043

§ 371 Date: Jul. 29, 2015

(30) Foreign Application Priority Data
Jan. 30, 2013 (SG) 201300762-0

(51) Int. Cl. C09D 5/16; C09D 145/00; B05D 7/00; C09D 123/22

(52) U.S. Cl. CPC C09D 5/1637; C09D 123/22; C09D 145/00; B05D 7/52

(57) ABSTRACT

The present invention relates to a method and polymer for improving stability of Layer-by-Layer (LbL) assemblies or films such as for antifouling performances in a sea water environment. Stability enhancement is achieved by an application of a custom made polyanion that can be easily crosslinked in a mild condition without any other chemical addition, or high energy radiation, to form covalent bond, with any polyamines.

This application claims priority benefit of Singaporean patent application number 201300762-0 filed 30 Jan. 2013, the contents of which are incorporated by reference herein in their entirety.

### FIELD

The present invention relates to a method and polymer for improving stability of Layer-by-Layer (LbL) assemblies or films such as for antifouling coatings in a sea water environment, and to such assemblies and their manufacture and use.

### BACKGROUND

Marine fouling refers to the undesirable accumulation of microorganisms, plants, and animals on surfaces of man-made objects submerged in seawater. In general, the establishment of a marine fouling community goes through a few stages. Immersed substrate surfaces initially accumulate proteins, and then microorganisms such as bacteria, diatoms (eg. Amphora), spores of macroalgae and protozoa will build up biofilms. Subsequently, a range of macrofouling organisms will settle over these biofilms forming a marine fouling community.^{[1]} Some macrofoulers, such as cyprids (cypris larvae) of the sub-tropical barnacle, Balanus amphitrite, will settle readily on clean surfaces where no biofilm is present.^{[2]} Barnacles are cosmopolitan and hardy pest species and are often found soon after immersion. These are aggressive fouling species that can cause wide-spread and serious marine biofouling over a short duration. As such, they are widely used as the model organism for antifouling research.

An example of the impact of marine fouling may be observed in the efficiency decline of propulsion of ships. It is also a major problem for harbor installations, oil rigs, underwater sensors, pipelines, aquaculture, and for many other branches of maritime industries. For example, the accuracy of underwater sensors may be seriously reduced as the result of biofouling obstructing the surfaces which transmit signals. Biofouling will block valves, orifices and other constricted places when it occurs in pipes and conduits used to conduct seawater both in ships and in industrial installations on shore.^{[3]}

The use of toxic tributyl tin (TBT) paints, killing non-target organisms even at a very low concentration (<1 ng/L), have been prohibited by the International Maritime Organization (IMO) since January 2003 on any type of vessel.^{[4]} There is tremendous current legislative and societal pressure worldwide to avoid the use of such biocides and provide alternative environmental friendly preventive approaches.

It has been demonstrated that marine fouling is affected by substrate surface properties such as morphology^{[5]}, surface free energy^{[6]} and surface charge.^{[7]} Researchers have developed biomimetic surfaces such as sharkskin with nanoforce gradients for antifouling purpose.^{[8]} Decreasing the roughness of the substrate surface is another strategy to control biofouling.^{[9]} These low surface free energy coatings based on silicones or fluorinated polymers reduce the interaction strength between the substrate surface and the marine foulants, thus resulting in its detachment by hydrodynamic forces when vessels are moving.^{[10]} Electrostatic attraction plays an important role in the initiation of marine fouling, since most of the foulants that can attach onto the substrate surface are charged such as bacteria and proteins. Thus, various approaches have been attempted to modify the charge of the substrate surfaces to prevent the initial attachment of foulants. For example, positively and negatively charged monomers were graft polymerized from a polypropylene surface. The results indicated that the positively charged surface could effectively kill the attached bacteria; the negatively charged surface could repel the negatively charged bacteria; and the surface with balanced positive and negative charges exhibited the best non-fouling performance for the bacteria.^{[11]} Another more convenient, cheaper and faster method to prepare a charged surface, is the Layer-by-Layer (LbL) deposition of polyelectrolytes.^{[12]} Polyelectrolyte multilayers assembled with poly(allylamine hydrochloride) and poly(sodium 4-styrene sulfonate) (SPS) exhibited antimicrobial property without the addition of specific biocides.^{[13]} Zwitterionic sulfobetaine methacrylate was copolymerized with acrylic acid and LbL deposited with polyethylenimine onto polymeric substrates to resist platelet adhesion.^{[14]} LbL films formed by alternate deposition of a block copolymer comprising polystyrene sulfonate and highly hydrophilic poly(poly(ethylene glycol) methyl ether acrylate) and polyallylamine hydrochloride exhibited low protein and cell binding characteristics.^{[15]}

However, only very limited research works focused on preparing charged surfaces by LbL assembly for resisting marine fouling has been reported. For example, LbL multilayers built up by oppositely charged poly(acrylic acid) and polyethylenimine polyelectrolytes after modification with poly(ethylene glycol) and tridecafluoroctyltriethoxysilane were used to resist the attachment of spores of green alga Ulva.^{[16]}

It is recognized that surface micropatterning may prevent biofouling to some extent. One of the studied approaches is to combine micro patterning with chemical modification of the surface. However, not all methods are suitable to use with micropatterning—firstly deposited or grown chemical layers have to be very stable in sea water environment, secondly layers have to be rather thin (sub 200 nm) to avoid covering features of micrometer size patterns. It is well known that the seawater is highly corrosive. Thus, the stability of the deposited LbL films is a key factor to achieve long term performance. Crosslinking is an effective method to improve the stability of the deposited polyelectrolyte films. For example, the deposited poly(styrenesulfonate)/poly(allylamine hydrochloride) microcapsules were chemically crosslinked by glutaraldehyde.^{[17]} High energy such as UV radiation was also used to crosslink poly(acrylic acid-g-azidoaniline) with poly(ethylenimine).^{[15]} In addition, poly(acrylic acid) and polyethylenimine LbL films were crosslinked in high temperature (160° C.) and high vacuum (4×10⁻² mbar) condition.^{[17]}

### SUMMARY

Marine fouling is a major problem for harbor installations, oil rigs, shipping vessels, underwater sensors, aquaculture, and for many other branches of maritime industries. Environmental friendly approaches for marine antifouling coatings are desired. The coating stability is also a major concern, due to the highly corrosive marine environment. It is therefore desirable to provide a method and polymer for improving stability of LbL films for antifouling performances in a sea water environment.

Research using layer-by-layer (LbL) assembled thin films for marine antifouling applications is in its infancy. LbL techniques however are an attractive approach for the fabrication of anti-fouling coatings, in particular because they are convenient and comparatively inexpensive to prepare (the polymeric films can be prepared by alternately dipping the surface to be coated in oppositely charged polyelectrolyte solutions or by alternately spraying oppositely charged polyelectrolyte solutions onto the surface). These methods are particularly useful for controlling film thickness and can be easily used to fabricate films having zero net charge.

Typically, the layers are held together by electrostatic interactions. However, the location of these assemblies during use as antifouling coatings, for example, in highly corrosive marine environments, means that the stability of conventional LbL assemblies can be a concern. The present invention is based on the inventors' insight that covalent bonds may be used to cross-link the alternating layers in LbL assemblies used as marine antifouling coatings under commercially friendly conditions, thereby enhancing the stability.

Earlier research has shown that covalent bonds may be used to cross-link layers in LbL assemblies. However, these covalent LbL approaches require specialized, sophisticated macromolecules, and high energy or very forcing reaction conditions, limiting the use of these approaches for marine antifouling coatings, where very large structures may need to be covered. Furthermore, such approaches may not result in films with net zero charge. Examples of previous methods and approaches are described in the background section, and include UV irradiation to effect nitrene formation of an azide moiety followed by N—H bond insertion;^{[15]} chemical reactions using additional reagents;^{[17]} and high temperature and vacuum forcing reaction conditions.^{[17]}

The present invention seeks to address these problems, and others, by the provision of an anionic polymer that is able to form covalent bonds with an alternating cationic polyelectrolyte in an LbL assembly under mild conditions.

Accordingly, the present invention relates to layer-by-layer polyelectrolyte assembles that comprise alternate layers of anionic polyelectrolyte and cationic polyelectrolyte, the layers being cross-linked, or cross-linkable. The assemblies provide a coating on a substrate to resist or prevent marine biofouling.

By providing an anionic polyelectrolyte that has substituent groups capable of undergoing a cross-linking nucleophilic substitution reaction with substituent groups of the cationic polyelectrolyte to form cross-linking covalent bonds, such cross-linking can occur under mild conditions, for example, under comparatively low annealing temperatures and without the need for forcing conditions or irradiation and/or additional reagents. This represents a significant advantage over known methods, making fabrication of stable cross-linked layer-by-layer polyelectrolyte assemblies easier, safer and more environmentally friendly.

Accordingly, in a first aspect, the present invention may provide a layer-by-layer polyelectrolyte assembly on a substrate for resisting marine biofouling, the assembly comprising an anionic polyelectrolyte layer cross-linked by covalent bonds to a cationic polyelectrolyte layer. Suitably, the covalent bonds are amide bonds. Amide bonds are advantageous owing to their stability and ease of formation.

For example, the anionic polyelectrolyte may comprise units of formula:

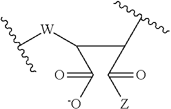

wherein W is optionally substituted C_{1∝}alkylene and Z is a bond to the cationic polyelectrolyte.

It will be appreciated that layer-by-layer polyelectrolyte coatings may be applied to a substrate in sequential layer deposition, with the cross-linking reaction occurring later, for example, on subsequent annealing after the desired number of layers has been applied.

Accordingly, in a further aspect, the present invention may provide a layer-by-layer polyelectrolyte assembly on a substrate for resisting marine biofouling, the assembly comprising an anionic polyelectrolyte layer and a cationic polyelectrolyte layer, wherein the cationic polyelectrolyte has substituent groups capable of undergoing a cross-linking nucleophilic substitution reaction with substituent groups of the anionic polyelectrolyte to form cross-linking covalent bonds. That is, one type of polyelectrolyte may have substituents that are nucleophiles, while the other may have groups capable of being displaced by said nucleophiles to form a covalent bond between the two polyelectrolytes.

The formation of a cross-linking bond by nucleophilic substitution reaction may result in loss of an alcohol, for example, an alkyl alcohol, for example, methanol. It may be nucleophilic acyl substitution, for example, it may be amide formation between an amine and an ester with loss of an alcohol.

The layer-by-layer polyelectrolyte assembly is for resisting marine biofouling, that is, it may be an anti-marine biofouling coating/a biofouler resistant coating used on, for example, the hulls of vessels (for example, ships, boats, submarines), on harbour structures (for example, piers) and on oil rigs.

Suitably, the anionic polyelectrolyte comprises anionic repeating units which comprise anionic repeating groups, for example, carboxylic, sulfonic and/or phosphoric acid groups. Preferably, the anionic repeating groups are carboxylic acid groups.

Suitably, the covalent bonds are amide bonds. Amide bonds are advantageous owing to their stability and ease of formation.

Suitably the cationic polyelectrolyte is a polyamine bearing —NH₂ and/or —NH— functional groups, for example, the cationic polyelectrolyte may be polyethylenimine (PEI).

The nature of the anionic polyelectrolyte may permit, in combination with cationic polyelectrolytes as described herein, the fabrication of layer-by-layer polyelectrolyte assemblies that undergo cross-linking reactions under conditions as described herein.

Accordingly, in a further aspect the present invention may provide an anionic polyelectrolyte for the fabrication of a polyelectrolyte layer-by-layer assembly for resisting marine biofouling, the anionic polyelectrolyte having repeating anionic groups selected from carboxylic acid groups, sulphonic acid groups and phosphoric acid groups; and having crosslinking leaving groups.

Suitably, the crosslinking leaving groups form or are part of substituent groups capable of undergoing a nucleophilic substitution reaction with a nucleophilic substituent on the cationic polyeletrolyte, for example, with an amine.

The crosslinking leaving group may leave in its entirety, for example, in an S_{N}1 or S_{N}2 type reaction, or may participate in a nucleophilic aryl substitution reaction, to form, for example, an amide bond. Put another way, in embodiments the cross-linking leaving groups may be part of an activated carboxylic acid, for example, an ester, with aminolysis of the ester bond giving the amide bond.

In a further aspect the present invention may provide an anionic polyelectrolyte for the fabrication of a polyelectrolyte layer-by-layer assembly for resisting marine biofouling, the anionic polyelectrolyte having repeating anionic groups selected from carboxylic acid groups, sulphonic acid groups and phosphoric acid groups; and having repeating activated carboxylic acid groups. Suitably, the activated carboxylic acid groups are esters, for example, C₁₋₄akyl esters such as methyl esters, or acyl halides.

The anionic polyelectrolyte′ comprises anionic repeating units; and cross-linking leaving group units. Anionic repeating units have at least one anionic group, for example, a carboxylic, sulfonic or phosphoric acid group and do not contain a cross-linking leaving group. Cross-linking leaving group units include a cross-linking leaving group, which may be part of activated carboxylic group, and may further comprise an anionic group.

Suitably, there may be more anionic groups than cross-linking leaving groups; for example, they may be in a ratio from 1000:1 to >1:1. In embodiments, the ratio may be from 500:1 to >1:1, more preferably from 400:1 to >1:1, more preferably from 300:1 to >1:1, more preferably from 200:1 to >1:1, more preferably from 100:1 to >1:1, more preferably from 50:1 to >1:1, more preferably from 20:1 to >1:1, more preferably from 15:1 to >1:1, more preferably from 15:1 to 5:1.

Suitably, the repeating anionic groups are carboxylic acid groups.

Activated carboxylic acid groups may be carboxylic ester group repeating units, for example alkyl esters, aryl esters and benzyl esters, that is, cross-linking leaving groups may be part of carboxylic ester groups, for example alkyl esters, aryl esters and benzyl esters. Preferred ester groups include methyl ester, ethyl ester, pentafluorophenyl ester, benzyl ester, nitrobenzyl, mono-, bi-, tri- tera-, or pentafluorobenzyl ester.

Cross-linking leaving groups may also refer to the leaving groups of acyl halides, for example, acyl chlorides and acyl imidazoles. Other suitable cross-linking leaving groups are known in the art, and may be obtained, for example, from the corresponding carboxylic acid using a peptide coupling reagent.

The anionic polyelectrolyte may have a molecular mass from 5 kD to 10,000 kD.

Suitably, the cross-linking covalent bonds are amide bonds. For example, the cationic polyelectrolyte may be a polyamine bearing —NH₂ and/or —NH— functional groups.

The present invention also relates to methods of fabrication of such assemblies, the methods comprising depositing first one polyelectrolyte layer on a suitable substrate, then a second, alternate, polyelectrolyte layer onto that layer (optionally repeating the depositing of alternate layers) to build up an assembly, then annealing the assembly to facilitate the formation of cross-linking covalent bonds between the layers.

The alternating layers are a cationic polyelectrolyte and an anionic polyelectrolyte, wherein the cationic polyelectrolyte has substituent groups capable of undergoing a cross-linking nucleophilic substitution with substituent groups of the anionic polyelectrolyte to form cross-linking covalent bonds.

Accordingly, in a further aspect, the present invention may provide a method of fabrication of a layer-by-layer polyelectrolyte assembly, the method comprising:
a) depositing a layer of anionic polyelectrolyte or cationic polyelectrolyte onto a substrate;
b) depositing a layer of either:
   (i) where the layer in (a) was anionic polyelectrolyte, a layer of cationic polyelectrolyte, or
   (ii) where the layer in (a) was cationic polyelectrolyte, a layer of anionic polyelectrolyte;
   wherein the cationic polyelectrolyte has substituent groups capable of undergoing a cross-linking nucleophilic substitution with substituent groups of the anionic polyelectrolyte to form cross-linking covalent bonds;
c) subjecting said layer-by-layer assembly to conditions to facilitate the formation of cross-linking covalent bonds between the layers.

As described herein, the substrate is suitable for supporting a layer-by-layer assembly as described herein. Suitably, the substrate may have charged groups on its surface.

The step of forming the covalent bonds may comprise, for example, annealing the layer-by-layer polyelectrolyte assembly. Suitably, the temperature may be between 25° C. and 150° C., more preferably between 25° C. and 120° C., more preferably between 25° C. and 100° C., preferably between 25° C. and 90° C., more preferably between 25° C. and 80° C., more preferably between 30° C. and 80° C., more preferably between 40° C. and 80° C., most preferably, between 50° C. and 70° C. A particularly preferred temperature is about 60° C. A vacuum may be applied to help to drive the reaction, for example, by removing a volatile by-product. Other methods that may be suitable for facilitating the reaction will be apparent to one skilled in the art and may include drying with a flow of gas, for example a stream of air or nitrogen.

Suitably, the step of forming the covalent bonds may take less than 24 h, more preferably less than 18 h, more preferably less than 15 h, more preferably less than 10 h, more preferably less than 8 h, more preferably less than 7 h, most preferably less than 6 h. These short reaction times reduce the energy needed and increase ease of manufacture.

Suitably, anionic polyelectrolytes described herein may comprise units “A” and units “B”, wherein each unit A bears one or more carboxylic acid group, sulphonic acid group or phosphonic acid group, and wherein each unit B bears a substituent group capable of undergoing a cross-linking nucleophilic substitution reaction, for example, a —(CO)LG group, wherein LG is as described herein. Suitably, each unit A does not bear a substituent group capable of undergoing a cross-linking nucleophilic substitution reaction. Each unit B may have one or more carboxylic acid group, sulphonic acid group or phosphonic acid group.

It will be appreciated that further units, C, may be present in the anionic polyeletrolyte. Suitably, the anionic polyelectrolyte comprises mostly units A and B, for example, more than 50% of the anionic polyelectrolyte may be composed of units A and B, more preferably more than 60%, more preferably more than 70%, more preferably more than 80%, more preferably more than 90%, most preferably more than 95%. In some embodiments, the anionic polyelectrolyte is composed entirely of units A and B as described.

The anionic polyelectrolyte may have a statistical arrangement of A and B, and optionally C, units, for example, it may be random co-polymer, or may be in the form of a block co-polymer.

In some embodiments, unit B has the formula:

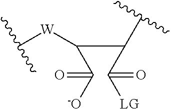

wherein W is optionally substituted C₁₋₄alkylene;
and LG is a leaving group.

In some embodiments, unit A has the formula:

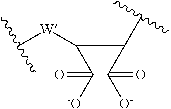

wherein W′ is optionally substituted C₁₋₄alkylene.

The anionic polyelectrolytes described herein may have a backbone of generic structure:

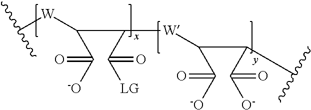

W and W′ are independently optionally substituted C₁₋₄alkylene; and
LG is a leaving group.

Suitably, x+y=10 to 10000 and 0<x/y≦1;

In embodiments, the ratio of y to x may be from 500:1 to 1:1, more preferably from 400:1 to 1:1, more preferably from 300:1 to 1:1, more preferably from 200:1 to 1:1, more preferably from 100:1, to 1:1, more preferably from 50:1 to 1:1, more preferably from 20:1 to 1:1, more preferably from 20:1 to 5:1, more preferably from 18:1 to 5:1, more preferably from 15:1 to 10:1.

Units may be arranged in a statistical arrangement, or may be in the form of a block co-polymer.

W and W′ are independently optionally substituted C₁₋₄alkylene. Optional substituents may include C₁₋₄alkyl, C₁₋₄alkoxy, and styrene. Other substituents that are small and inert may also be envisaged.

Suitably, W and W′ are C₂-alkylenes of formula:

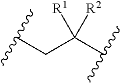

wherein R¹ and R² are each independently selected from H, C₁₋₄alkyl, C₁₋₄alkoxy and styrene. Preferably, R¹ and R² are each independently selected from H or C₁₋₄alkyl, more preferably, C₁₋₄alkyl, more preferably, methyl.

As used herein, LG is a leaving group, for example, LG may be OR³, wherein R³ is a small aliphatic group, preferably methyl; a C₆-aryl-CH₂ group, preferably benzyl, nitrobenzyl, mono-, bi-, tri-, tetra-, or pentafluorobenzyl; or pentafluorophenyl; or LG is halo, imidazole or a suitably activated carboxylic acid leaving group.

Suitably, the anionic polyelectrolyte may be obtained from a corresponding cyclic anhydride by hydrolysis and alcoholysis. For example, reactions using methanol may be used to incorporate methyl ester units. The number of methyl ester groups may be controlled by varying the amount of methanol added. A particularly preferred cyclic anhydride is poly(isobutylene-alt-maleic anhydride), and the present invention further provides use of poly(isobutylene-alt-maleic anhydride) in a method of manufacture of a polyelectrolyte layer-by-layer assembly for resisting marine biofouling.

A particularly preferred cationic polyelectrolyte is polyethylenimine.

The cross-linking reaction may cause the surface roughness of the assembly to reduce. That is, the surface roughness of the assembly after cross-linking may be less than it was prior to cross-linking. Suitably, the post-cross-linked surface roughness may be less than 97% of the pre-cross-linked surface roughness, for example, it may be less than 95%, less than 90%, less than 85%.

In some embodiments, the post-cross-linked surface roughness may be between 70% and 90% of the pre-cross-linked surface roughness, more preferably between 70% and 85%.

Put another way, the cross-linking reaction may result in a decrease in overall surface roughness of more than 5% of the pre-cross-linked assembly, preferably more than 10%, more preferably more than 15%, most preferably around 15-20%.

Assembly surface roughness may be measured as described herein using AFM techniques.

The cross-linking bonds improve the stability of the assemblies and may result in significantly reducing swelling during, for example, immersion in sea water. This may be measured as a function of the thickness of the assembly.

In some embodiments, the cross-linked assemblies described herein have a thickness that is less than 120%, more preferably less than 110%, of the original cross-linked thickness after 5 d immersion in seawater (the seawater may be artificial or real, as described herein), while retaining the same overall number of layers. Put another way, cross-linked assemblies as described herein may, when immersed in seawater for 5 d, swell in thickness by less than 20%, more preferably, less than 10%, of the original thickness.

In some embodiments, the cross-linked assemblies described herein have a thickness that is less than 120%, more preferably less than 110%, of the original cross-linked thickness after 7 d immersion in seawater (artificial or real, as described herein), while retaining, the same overall number of layers. Put another way, cross-linked assemblies as described herein may, when immersed in seawater for 7 d, swell in thickness by less than 20%, more preferably, less than 10%.

Ingress of water and salt between layers may also cause increased surface roughness, with cross-linked assemblies being less susceptible than the pre-cross-linked assemblies. In some embodiments, after 5 d immersion in artificial seawater, the surface roughness of the cross-linked assembly may be less than 80% that of the analogous pre-cross-linked assembly, more preferably less than 70%, more preferably less than 60%.

The assemblies described herein may be used as coatings on the hulls of vessels (for example, ships, boats, submarines) and on marine structures, for example, harbour structures such as piers and oil rigs.

Accordingly, the present invention further provides a marine vessel having a coating comprising an assembly as described herein. In some embodiments, the marine vessel is a ship.

The assemblies described herein may also be used as coatings on the interior and/or exterior surfaces of pipes for carrying sea water.

The present invention also provides a marine structure having a coating comprising an assembly as described herein.

In a further aspect, the present invention relates to a polyanion for fabrication of layer by layer polyelectrolyte assemblies to resist marine biofouling, and to use of said polyanion in the fabrication of a polyelectrolyte layer-by-layer assembly for resisting marine biofouling. Suitably, the anionic polyelectrolyte has cross-linking leaving groups and anionic groups, for example, carboxylic, sulfonic and phosphoric acid groups. Suitably, there are more anionic groups than cross-linking leaving groups; for example, they may be in a ratio from 1000:1 to >1:1. Suitable cross-linking leaving groups are described herein.

In a further aspect, the present invention relates to an aqueous composition comprising an anionic polyelectrolyte as described herein. The aqueous composition may be suitable for direct application to assemble LbL assemblies as described herein. For example, in embodiments, the composition may have a concentration of anionic polyelectrolyte in the range 0.1 to 10 mg/mL. Concentrations in this range may be suitable for assembling LbL assemblies by sequential dipping as described herein. Layers may also be deposited by spraying techniques. Aqueous compositions suitable for spraying may have a concentration of anionic polyelectrolyte in the range 0.5 to 10 mg/mL.

The following sentences are provided to further understanding of the invention.

The problem(s) the present invention seeks to ameliorate or solve includes the following:
Decrease of settlement from marine organisms by application of stable polymeric film of low thickness to be later used in combination with patterned surfaces.
Fabrication of a thin antifouling polymeric film in such a way that it will withstand highly corrosive sea water environment.
Overcome LbL, films stability issue by an effective crosslinking in the way that (1) mild conditions are applied (2) film is maintaining its initial LbL morphology and performance.

How the present invention ameliorates or overcomes the above-mentioned problem(s) includes the following:
Proposed LbL films could effectively prevent marine biofouling, as shown in preliminary lab testing.
The crosslinked LbL film exhibited high stability in seawater, indicating long term antifouling performance.
The crosslinking of the deposited LbL film could be conducted in a mild condition, not affecting film morphology and integrity.

One feature of the novelty of present invention lays in development of a novel polymer allowing for a mild crosslinking of LbL. Those films possess improved stability in sea water environment combined with good antifouling performance.

It will be apparent that options and preferences may be combined and may apply to any of the aspects or embodiments described herein unless context dictates otherwise. For example, and not by way of limitation, options and preferences with respect to the polyelectrolytes themselves may apply to the assemblies, methods and uses, while options and preferences with respect to the methods and used may apply to the assemblies and polyelectrolytes.

Other aspects and advantages of the present invention will become apparent to those skilled in the art from a review of the ensuing description, which proceeds with reference to the following illustrative drawings of preferred embodiments.

### BRIEF DESCRIPTION OF THE DRAWINGS

Embodiments of the invention will now be described, by way of example only, with reference to the accompanying drawings, in which:

FIG. 1: The synthesis of P1 and P2.

FIG. 2: Crosslinking reaction of the deposited P1 and branched PEI. Crosslinking density can be controlled by the amount of the methyl ester.

FIG. 3: FTIR spectra of the polyelectrolytes before and after crosslinking.

FIG. 4: XPS spectra of the N atom (1 s) of the polyelectrolytes before (left) and after (right) crosslinking.

FIG. 5: Thickness of the deposited LbL films before and after crosslinking.

FIG. 6: AFM images of the deposited multilayers before and after crosslinking.

FIG. 7: The differences in thickness of the LbL deposited films before and after artificial (a) seawater, (b) DMSO immersions and (c) real seawater.

FIG. 8: Number of cells on the control silicon surface, surface with uncrosslinked LbL film and surface with crosslinked LbL film after amphora incubation.

FIG. 9: Images of silicon surfaces without (left) and with (right) the crosslinked LbL film after cyprids incubation.

FIG. 10: LbL deposition.

FIG. 11: LbL assembly and cross-linking of the deposited polymeric layers.

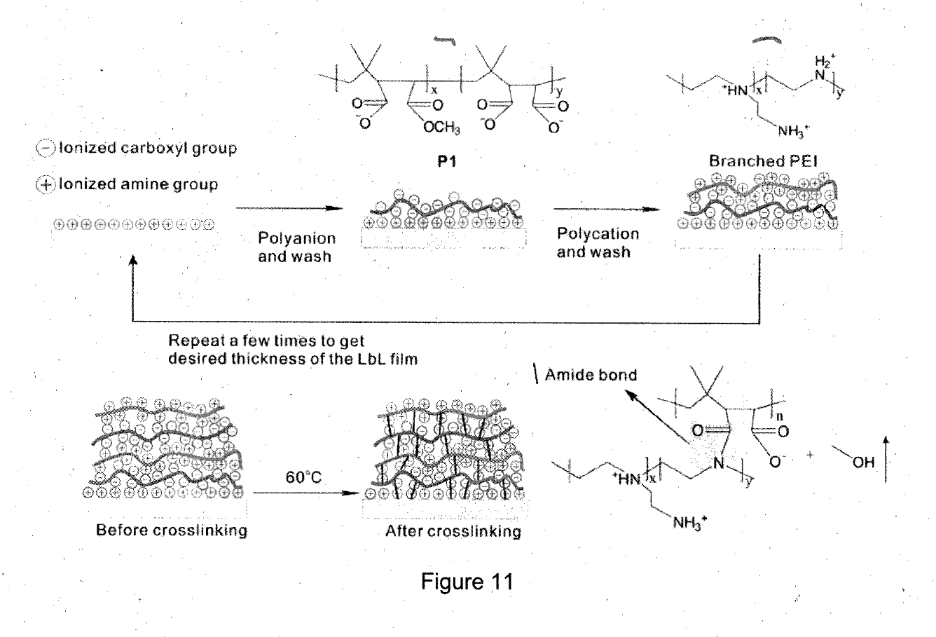

FIG. 12: AFM images of an LbL film (6 layers) without (a, R_{q}=13.04 nm) and with (b, R_{q}=6.58 nm) cross-linking in artificial seawater after 5 days immersion (measured by AFM in a liquid cell).

FIG. 13: (a) AFM measured thickness increase for positive as well as negative layer deposited; (b) distribution of hydrodynamic diameter of polymer aggregates for PEI and P1 in solution.

FIG. 14: FTIR spectra of PIAMA, P1, and P2.

FIG. 15: NMR spectra of P1 and P2.

### DETAILED DESCRIPTION

This disclosure describes a method and polymer for improving stability of LbL films in a sea water environment. Stability enhancement is achieved by an application of a custom made polyanion that can be easily crosslinked in a mild condition without any other chemical addition, or high energy radiation, to form covalent bond, with for example any polyamines.

The cross-linking may occur through a nucleophilic substitution, that is, by displacement of a suitable leaving group with a suitable nucleophile, as described herein.

In some embodiments, the novel polyanion includes two types of repeating groups, namely carboxylic acid and methyl ester. The methyl ester is able to undergo the cross-linking nucleophilic acyl substitution, that is, —OMe is the suitable leaving group. The resultant methanol may be driven off as vapour, thereby driving the reaction. Suitable nucleophiles may include alcohols (transesterification) and amines (amide formation). Due to high control over number of methyl ester groups introduced, high control over crosslinking density is available.

Material performance testing was carried out on the model LbL films, composed of a novel polymer and polyethyleneimine deposited on silicon wafers. Comparative study between crosslinked and non-crosslinked films was performed. The synthesis and crosslinking reactions were verified with ¹H NMR, FTIR and XPS spectra. The morphology and thickness of the deposited multilayers were observed with AFM. One important feature of the invented method is a very low impact of the crosslinking on the morphology and structure of the LbL structure. As observed by AFM, crosslinking did not create additional stress in the film and no cracks or dislocations were visible. The antifouling performances of the LbL multilayers were evaluated in the lab scale with typical marine fouling organisms (barnacle: cypris larvae, algae: amphora) and in a real tropical marine sea water test. Invented improvement of LbL stability is not limited to presented pair of polyelectrolytes, but can be extended to mixed layers e.g. few bi-layers composed of polymers of different functionality (higher antifouling performance) and few bi-layers composed of a novel polymer for improved stability.

The novel features and uniqueness of technology include, but are not limited to, the following:
Development of the novel polymer for LbL assembly, controllable crosslinking in mild conditions.
The crosslinking process of the deposited LbL film is conducted without affecting film morphology and integrity.
Improved stability combined with good antifouling performance of the LbL films in sea water environment.

The advantages of the present invention include, but are not limited to, the following:
Proposed LbL films could effectively prevent marine biofouling, as shown in preliminary lab tests.
The crosslinked LbL film exhibited high stability in seawater, indicating long term antifouling performance.
The novel polymer can be used as an effective crosslinking agent to form stable covalent bonds between amino groups which are common in polymers.

The potential applications for this method include, but are not limited to, the following. This method can be used by ship industry, harbor installations, oil rigs, underwater sensors, pipelines, aquaculture, and for many other branches of maritime industries. The potential products resulting from this invention range from LbL thin film coatings to coating stabilizing additives.

### DEFINITIONS

As used herein, the term “fouling” refers to the attachment and growth of microorganisms and small organisms to a substrate exposed to, or immersed in, a liquid medium, for example an aqueous medium, as well as to an increase in number of the microorganisms and/or small organisms in a container of the liquid medium.

Accordingly “foulers” or “microfoulers” are used interchangeably and refer to the organisms that foul a substrate. Fouling may occur in structures exposed to or immersed in fresh water as well as in sea water. In particular, the term may be used to refer to a solid medium or substrate exposed to, or immersed in sea water.

Accordingly, the term “antifouling” refers to the effect of preventing, reducing and/or eliminating fouling. Antifouling agents or compounds are also called “antifoulants”. The term “resisting” marine biofouling will be appreciated to refer to the prevention, reduction and/or elimination of fouling. For example, an anti-fouling surface may have fewer than 30%, more preferably fewer than 20% of the number of cyprids adhered to the surface after 24 h of immersion in the Cyprids Adhesion Test as described herein when compared to a control (silicon wafer). Suitably, in the Cyprids Adhesion Test as described herein, the cyprid density may be less than 3 cyprid/cm2, more preferably less than 2 cyprid/cm2, more preferably less than 1 cyprid/cm2, most preferably less than 0.5 cyprid/cm2.

The term “substrate” as used herein refers to a solid medium such as surfaces of structures or vessels exposed to, or immersed in a liquid medium. The liquid medium may be fresh water or seawater and may be a body of water in a manmade container such as a bottle, pool or tank, or the liquid may be uncontained by any manmade container such as seawater in the open sea. Suitably, substrates may have charged groups on their surface to facilitate deposition of a layer-by-layer assembly, that is, surfaces of substrates may be “activated and/or functionalised”. Suitable methods for preparing surfaces for polyelectrolyte assembly are known in the art and may include treatment of the surface with, for example, a silane having a functional amino group, for example with 3-aminopropyltrimethoxysilane as described herein. Other methods of preparing surfaces for known in the art include applying a gold coating then applying a self-assembling monolayer of, for example, thiols having an amino functional group.

A “structure” as used herein refers to natural geological or manmade structures such as piers or oil rigs and the term “vessel” refers to manmade vehicles used in water such as boats and ships. In some embodiments, the structure is the hull of a vessel. In some embodiments, the structure is a harbour rig. In some embodiments, the structure is an oil rig.

The “microorganisms” referred to herein include viruses, bacteria, fungi, algae and protozoans. “Small organisms” referred to herein can include organisms that commonly foul substrates exposed to, or immersed in, fresh water or seawater such as crustaceans, bryozoans and molluscs, particularly those that adhere to a substrate. Examples of such small organisms include barnacles and mussels and their larvae. Small organisms can also be called small animals. The term “organism” referred to herein is to be understood accordingly and includes microorganisms and small organisms.

The term “marine organism” as used herein refers to organisms whose natural habitat is sea water. The terms “marine microorganism” and “marine small organism” are to be understood accordingly.

### Chemical Terms

“Layer-by-layer assemblies” as described herein are multilayer assemblies comprising at least two polyelectrolyte layers: a cationic layer and an anionic layer, which may be termed herein a polycation and a polyanion, respectively. Of course, more than two layers may be envisaged, and indeed may be preferable. Assembles having more than two layers feature alternate cationic layers and anionic layers, and the total number of layers may be odd or even, that is, the multilayer may consist only of pairs of layers (each pair comprising an anionic layer and a cationic layer, termed herein a “bilayer”), or may consist of one or more pairs of layers with a further, single anionic layer or cationic layer as appropriate. Accordingly, the layer-by-layer polyelectrolyte assemblies described herein may have 1, 1.5, 2, 2.5, 3, 3.5, 4, 4.5, 5, 5.5, 6, 6.5, 7, 7.5, 8, 8.5, 9, 9.5, 10 or even many more, bilayers. For example, use of an automated application process may be used to create assemblies having 100 or more bilayers. Suitably, the layer furthest from the substrate is a cationic electrolyte layer. Suitably, the layer-by-layer polyelectrolyte assembly has an integer number of bilayers. Preferably, the number of bilayers is between 3 and 9, more preferably, between 4 and 8, more preferably, between 5 and 7, most preferably, 6.

The term “alkyl,” as used herein, pertains to a monovalent moiety obtained by removing a hydrogen atom from a carbon atom of a hydrocarbon compound having from 1 to 20 carbon atoms (unless otherwise specified), which may be aliphatic or alicyclic, and which may be saturated or unsaturated (e.g., partially unsaturated, fully unsaturated). Thus, the term “alkyl” includes the sub-classes alkenyl, alkenyl, cycloalkyl, cycloalkyenyl, cycloalkynyl, etc., discussed below.

In the context of alkyl groups, the prefixes (e.g., C₁ to C₄, C₁ to C₅, etc.) denote the number of carbon atoms, or range of number of carbon atoms. For example, the term “C₁ to C₄alkyl,” as used herein, pertains to an alkyl group having from 1 to 4 carbon atoms. Examples of groups of alkyl groups include C₁ to C₄ alkyl (“lower alkyl”), and C₂ to C₆ alkyl. Note that the first prefix may vary according to other limitations; for example, for unsaturated alkyl groups, the first prefix must be at least 2; for cyclic and branched alkyl groups, the first prefix must be at least 3; etc.

Examples of (unsubstituted) saturated alkyl groups include, but are not limited to, methyl (C₁), ethyl (C₂), propyl (C₃), butyl (C₄), pentyl (C₅) and hexyl (C₆).

The term “cross-link”, as used herein, is used to describe a bond that links one polymeric layer to another. As used herein, and unless expressly stated otherwise, references to cross-linking bonds refer to cross-linking covalent bonds, that is, to covalent bonds between polymeric layers. Cross-linking reactions are reactions that form such cross-linking covalent bonds.

The cross-linking bonds in assemblies, uses, and methods of the present invention are formed, or may be formed, by nucleophilic substitution reactions. The term is understood in the art, and involves the replacement of a leaving group with a nucleophile that selectivity bonds with or attacks the positive or partial positive charge at a point within a molecule. Nucleophilic substitution can occur at saturated carbon centres via, for example, S_{N}1 and S_{N}2 reactions. Nucleophilic substitution may also occur at unsaturated carbon centres, for example via nucleophilic acyl substitution. In nucleophilic acyl substitution reactions, a nucleophile attacks the carbon of carbonyl group to temporarily form a tetrahedral intermediate. The carbon-oxygen double bond is then regenerated with loss of a leaving group, that is, the nucleophile has replaced the leaving group. A representative schematic reaction mechanism for these reactions in basic conditions is shown below.

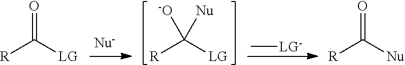

“Leaving group” as used herein refers to a chemical moiety that departs with a pair of electrons in heterolytic bond cleavage. Suitable leaving groups for chemical reactions as described herein will be apparent to the skilled person. They may include, for example, and not by way of limitation, alcohols and alkoxides (that is, a conjugate base of an alcohol), halogens, tosylates and mesylates. For example, in nucleophilic acyl substitution, suitable leaving groups include alcohols and alkoxides (that is, a conjugate base of an alcohol), for example, C₁₋₁₀alkyl alcohols, benzyl and substituted benzyl alcohols, substituted phenols, and conjugate bases thereof. Suitable leaving groups also include halogens (fluoride, chloride, bromide, iodide), imidazole, for example, via carbonyl diimidazole coupling, and triazoles. Carboxylic acids may be activated for nucleophilic acyl substitution with, for example, an amine to form an amide, using coupling reagents as known in the art. Accordingly, suitable leaving groups may be as generating during such coupling reactions. Suitable coupling regents include, but are not limited to, dicyclohexylcarbodiimide (DCC), diisopropylcarbodiimide (DIC), 1-hydroxy-benzotriazole (HOBt) and 1-hydroxy-7-aza-benzotriazole (HOAt). For example, the leaving group may be part of an O-acylisourea moiety.

“Activated carboxylic acid”, as used herein, is used to describe a chemical moiety that is primed to undergo a nucleophilic aryl substitution reaction as described herein. Accordingly, it may be used to describe a chemical moiety having the structure —(CO)-LG, wherein LG is a leaving group. LG may be OR³. In some embodiments, R³ is a small aliphatic group, for example, a C₁₋₄ alkyl, preferably methyl; a C₆-aryl-CH₂ group, preferably benzyl, nitrobenzyl, mono-, bi-, tri- tera-, or pentafluorobenzyl; or pentafluorophenyl; or LG is halo, imidazole, or —(CO)-LG represents the moiety generated using coupling reagents as described above.

### Experimental Section

### Materials

Poly(isobutylene-alt-maleic anhydride) (PIAMA, Mw: 60,000), polyethylenimine (PEI, Mw: ˜25,000, branched), 3-aminopropyltrimethoxysilane, 4-(dimethylamino)pyridine (DMAP) and sodium hydroxide were provided by Sigma Aldrich. Solvents including N,N-dimethylformamide (DMF), dimethylsulfoxide (DMSO), toluene, methanol and ethanol were purchased from Tedia. Dialysis membrane tubing (MWCO: 12,000 to 14,000) was received from Fisher Scientific. Silicon wafers were obtained from Latech Scientific Supply Pte. Ltd. Ultrapure water produced by Millipore Milli-Q integral water purification system was used to prepare water solutions in this study.

### Synthesis and Characterization of the Polyanion

PIAMA (1 g) (IR spectrum 1858 and 1777 cm⁻¹) and DMAP (0.026 g) as the catalyst were completely dissolved in 10 mL of DMF with 500 rpm magnetic stirring at 65° C. Subsequently, methanol (50 μL) was added into the solution to initiate the reaction. After 5 h reaction, the solution was slowly poured into 100 mL of NaOH water solution (10 g/L) with 500 rpm magnetic stirring at room temperature. When the solution became transparent and clear, it was transferred into the dialysis membrane tubing (1 m) and dialyzed against ultrapure water for 3 d with changes of water every 10 h. The purified polymer water solution was then concentrated by rotary evaporator and finally freeze dried to get the solid polyanion denoted as P1. On the other hand, PIAMA (1 g) was also directly dissolved in 100 mL of NaOH water solution (10 g/L) with 500 rpm magnetic stirring at room temperature. Similarly, the produced polymer denoted as P2 was purified by dialysis and freeze dried (1.16 g, 82.4%). Solid polymer samples were mixed with KBr and pressed into pellets by manual hydraulic press (Specac). The prepared pellets were analyzed by a Fourier transform infrared spectrometer (FTIR, Perkin Elmer). In addition, the polymer samples were dissolved in D₂O and analyzed by nuclear magnetic resonance (NMR, Bruker, 400 MHz) to get ¹H NMR spectra.

P1: NMR calculated Mn: 84 kDa. ¹H NMR integrated for a single repeating unit: (D₂O) δ_{H}: 1.07 (6H, m), 1.59 (0.48H, bs), 2.00 (0.94H, bs), 2.47 (0.70H, bs), 2.74 (0.79H, bs), 3.67 (0.25H, s). IR: 1788, 1731, 1580, 1471, 1396 cm¹.

P2: NMR calculated Mn: 84.2 kDa. ¹H NMR integrated for a single repeating unit: (D₂O) δ_{H} 1.05 (6H, m), 1.56 (0.96H, m), 1.95 (0.94H, s), 2.38 (0.97H, m), 2.72 (0.98H, m). IR: 1582, 1470, 1371 cm¹.

### Assembly and Characterization of the LbL Multilayers

Silicon wafers were cut into 2×2 cm pieces by DISCO dicing machine (DAD 321). After ultrasonically cleaned by water and ethanol for 10 min, respectively, they were dried by nitrogen stream. Subsequently, silicon wafers were treated by oxygen plasma (200 w) for 2 min in a triple P plasma processor (Duratek, Taiwan). The treated silicon wafers were immersed into the 3-aminopropyltrimethoxysilane toluene solution (10 mM) for 5 h to impart positively charged amino groups on the substrate surface.

The synthesized polyanions and PEI were dissolved in ultrapure water to give 1 mg/ml solutions, respectively. The pretreated silicon wafers with positively charges were immersed into the synthesized polyanion solution for 10 min, followed by ultrapure water rinse for 2 min.

Subsequently, they were immersed into PEI solution for 10 min, followed by 2 min ultrapure water rinse. This cycle was repeated until the desired bilayer number reached. The silicon wafers with the deposited LbL films were dried by nitrogen stream and completely dried under vacuum at room temperature for 5 h. The crosslinking process was easily conducted by heating the silicon wafers with the dried LbL films to 80° C. for 5 h under vacuum.

The deposited LbL films were analyzed by FTIR and X-ray photoelectron spectroscopy (XPS) before and after crosslinking. The FTIR measurements were taken by a Perkin Elmer FTIR spectroscopy with an attenuated total reflection component using ZeSe crystal. The XPS spectra of the deposited LbL films were obtained with a VG ESCALAB 250i-XL spectrometer using an. Al Kα X-ray source (1486.6 eV photons). XPS data processing, including peak assignment and peak fitting (fitting algorithm Simplex), was done using the software package Thermo Avantage, version 4.12 (Thermo Fisher Scientific).

Surface morphology and thickness of the deposited LbL films were measured by Bruker's Dimension® Icon™ atomic force microscope (AFM) system in a tapping mode. AFM images were taken on dried films with an area of 2×2 μm for morphology observation and roughness measurement. The film thickness was measured by scratching the multilayer assembly with a fresh razor blade to expose the bare substrate (silicon) and then scanning it with an area of 10×10 μm to reveal a clear step at the scratch.^{[18]} The blade can penetrate the polymer films to the silicon substrate but no further because the hardness of the blade is higher than the polymer films but lower than the silicon substrate. The height difference between the thin film and the bare substrate was considered as the thickness of the film (Tables 1 and 2). Five sections crossing of a single scratch were used to measure height difference. The AFM raw data were processed by software (NanoScope Analysis, Bruker).

TABLE 1

| | | | Before | |
|---|---|---|---|---|
| Number of | After crosslinking | | crosslinking | |
| bilayers | (nm) | SD | (nm) | SD |
| 2 | 7.6 | 0.4 | 7.7 | 1.1 |
| 3 | 10.0 | 1 | 9.4 | 0.2 |
| 4 | 30.2 | 2.6 | 19.9 | 3.9 |
| 5 | 48.2 | 3.1 | 41.8 | 1.7 |
| 6 | 64.1 | 3.5 | 79.6 | 1.4 |
| 7 | 114.0 | 6.9 | 112.8 | 5.5 |
| 8 | 164.4 | 4.6 | 145.0 | 6.8 |
| 9 | 204.2 | 9.7 | 176.4 | 9.0 |
| 10 | 233.3 | 6.8 | 217.5 | 7.5 |
| 11 | 284.1 | 20.0 | 261.2 | 24.0 |

TABLE 2

| Number of | After crosslinking | |
|---|---|---|
| bilayers | (nm) | SD |
| 4.0 | 30.2 | 2.6 |
| 4.5 | 44.6 | 3.7 |
| 5.0 | 48.2 | 3.1 |
| 5.5 | 61.2 | 7.6 |
| 6.0 | 64.1 | 3.5 |
| 6.5 | 99.7 | 9.6 |
| 7.0 | 114.0 | 6.9 |

Stability of the deposited LbL films before and after crosslinking were evaluated by artificial and real seawater and solvent immersion tests. The silicon wafers with 6 bilayers films were immersed into artificial seawater prepared by sea salts (40 g/L, Sigma), real seawater (natural tropical water by immersing coupons in the sea off the West Coast of Singapore) and DMSO for up to 7 d. In the field immersion test, the coupons were secured to frames and suspended at a depth of 0.5 m. Samples were moved out and rinsed by ultrapure water after 1, 3, 5 and 7 d immersions. After drying under vacuum at room temperature for 5 h, the thickness of the film on the silicon wafer was measured following the method mentioned above. The morphologies of the LbL films were also directly observed when immersed in artificial seawater (ASW) solution using a liquid AFM cell (JPK, NanoWizard 3 NanoOptics).

Amphora adhesion

Amphora species are the most commonly encountered raphid diatoms found in biofilms on submerged surfaces and as such are often used in antifouling tests. Amphora coffeaeformis (UTEX reference number B2080) was maintained in F/2 medium in tissue culture flasks at 24° C. under a 12 h light: 12 h dark regime for at least a week prior to use. The algae were gently removed from culture flasks with cell scrapper and clumps were broken up by continuous pipetting and filtering through a 35 μm nitex mesh. The cell count was determined with a hemocytometer and a suspension containing 10 000 cells per mL was made up in 3% salinity, 0.22 am filtered seawater (FSW). Silicon wafer controls, silicon wafers with LbL films, with and without cross-links were placed randomly in each well, in 6-well Nunc multiwell culture plates, with 8 replicates for each treatment. To each well, 5 mL of algal cell suspension was added. The experiment was allowed to incubate for 24 h in a 12 h light: 12 h dark cycle at 24° C. At the end of the incubation period, all slides were gently dipped in a beaker of 3% salinity, 0.22 μm FSW to rinse off any unattached cells. This rinse step was repeated three times. Slides were then allowed to air-dry: The slides were examined under an epi-fluorescence microscope. Ten random fields of view were scored at 20× magnifications (0.916 mm² per field of view) for each slide.

In brief, seawater was filtered by membranes (0.22 μm) to remove particles. All surfaces were immersed in Amphora cell suspension (5000 cells/ml) and placed under a 12 h light: 12 h dark regime at 24 degrees celsius and allowed to incubate for 24 hours. After 24 hours, unattached cells were gently rinsed off with seawater (30 ppt, 0.22 um filtered) thrice. Silicon wafer were scored immediately without fixing. Scoring was done at 20× objective with UV and cells from 10 random fields of view were counted; each field of view has an area of 0.916 mm².

### Cyprids Adhesion

Amphibalanus Amphitrite barnacle larvae were spawned from adults collected from the Kranji mangrove, Singapore. The nauplius larvae were fed with an algal mixture 1:1 v/v of Tetraselmis suecica (CSIRO Strain number CS-187) and Chaetoceros muelleri (CSIRO Strain number CS-176) at a density of ˜5×105/mL, and reared at 27° C. in 2.7% salinity, 0.2 μm filtered seawater. Nauplii metamorphosed into cyprids in 5 days and cyprids were aged for minimum of 2 days at 46° C. prior to use in settlement assays. As a result of the inherent hydrophilicity of the cleaned silicon wafer, it was difficult to apply the sessile droplet assay for cyprid settlement. To evaluate the antibarnacle settlement properties of the untreated and LbL filmed silicon wafers, an experiment was set up wherein 4 day old cyprids were contained in a 50 μm Nitex mesh shaped to form a well approximately 16 cm in diameter with maximum depth of 5 cm, and enclosing a volume of approximately 1 L of seawater (2.7%, 0.22 μm filtered). In our study, we observed that cyprids of A. amphitrite did not settle on 50 μm nitex mesh. A total of 3000 cyprids were added into the enclosed net to give a concentration of approximately 3 cyprids per mL. Untreated and LbL polyion film covered silicon wafers (8 pieces each) were suspended in this cyprid culture and incubated in the dark at 27° C. for 24 h. A small pinhole was provided at one edge of each wafer and the wafers were hung vertically, suspended with a nylon thread, arranged in a random block design. After 24 h, the coupons were removed. The silicon wafers were photographed and the number of attached and settled cyprids on each piece of silicon wafers was counted.

In brief, seawater was filtered by membranes (0.22 μm) to remove particles. Cyprids (4 d old) were added into the filtered seawater to give a concentration at 3 cyprid/ml. Subsequently, untreated and polyelectrolyte film deposited silicon wafers were immersed in this seawater with cyprids at 27° C. for 24 h. After immersion, the surfaces of the silicon wafers were observed with a microscopy (Nikon). The settled amount of cyprids on each piece of silicon wafers was counted and recorded.

### Results and Discussion

### Characterization of the Synthesized Polyanions for the LbL Assembly

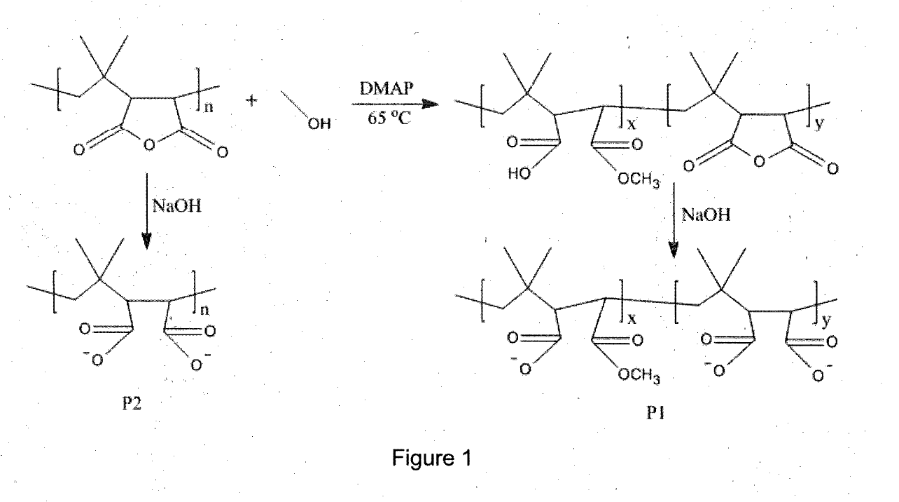

The novel polyanion (P1) for LbL assembly was synthesized from PIAMA through alcoholysis followed by NaOH hydrolysis as shown in FIG. 1. Besides a portion of PIAMA was ancoholyzed, the rest was directly hydrolyzed by NaOH to get negatively charged P2 (FIG. 1).

Upon introduction of methyl esters, the rest of the anhydride groups were hydrolyzed by NaOH. In this way polymer P1 with methyl ester groups, intended for crosslinking, and carboxylic groups for providing anionic character and water solubility was synthesized. In parallel, PIAMA was directly hydrolyzed by NaOH to produce polyanion P2, used as a reference.

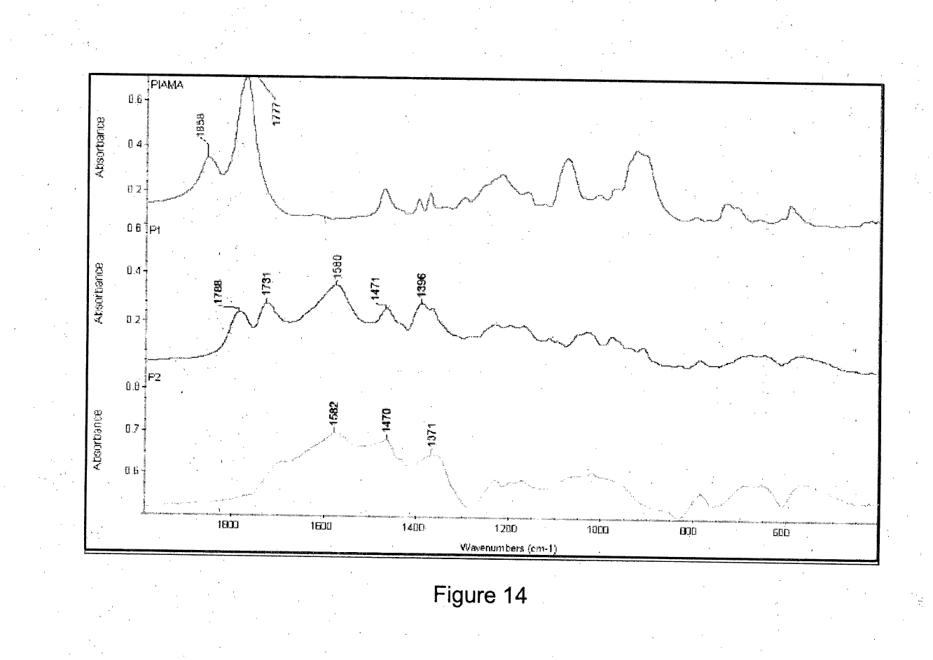

In order to verify the reactions, FTIR spectra of PIAMA, P1 and P2 were collected, as shown FIG. 14. The double peak (1858.46 cm⁻¹ and 1776.86 cm⁻¹) belonging to the C═O of anhydride disappeared in the FTIR spectra of P1 and P2, indicating the complete reaction of PIAMA.^{[19]} There was a unique peak only shown up in the P1's spectra at 1731.09 cm′ which belongs to the C═O of ester,^{[20]} indicating the successful reaction of alcoholysis. In addition, P1 and P2 shared a peak at around 1580 cm′ belonging to COO—, indicating the produced negatively charged groups of the polyanions which are ready for the LbL assembly.

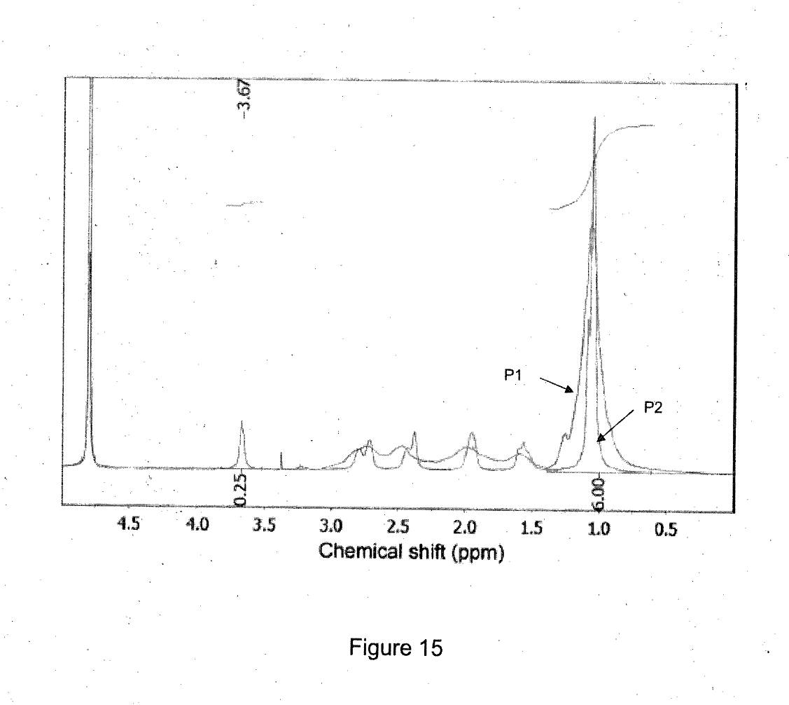

The alcoholysis reaction was further verified by 1H NMR spectra of P1 and P2 as shown in supporting information (FIG. 15). There was a peak (3.66 ppm) in the P1's spectra but not in the P2's spectra, which belongs to the methylene protons of methyl ester. It is obvious that the methyl ester was produced through the alcoholysis of PIAMA by methanol. According to the peak area ratio of the methylene protons of the produced methyl ester and the ethylene protons of the main chain at 2.76 ppm,^{[20]} the percentage of alcoholyzed PIAMA was estimated as 6.0 mol %. From the peak area ratio between the methyl ester protons and the dimethyl group protons of the main chain at around 1 ppm, the percentage of alcoholyzed groups can be estimated to 8% of repeating units. Therefore, indices x and y describing the composition of polymer P1 can be estimated to 30 and 360, respectively.

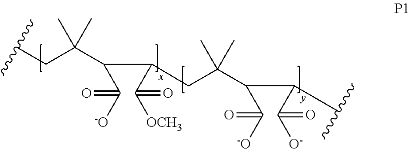

### Crosslinking of the Deposited LbL Assembly

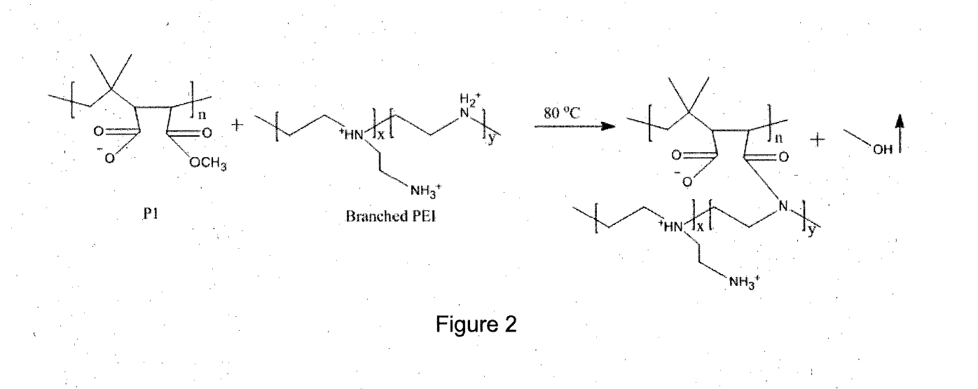

The prepared multilayers may be used for marine biofouling prevention. Therefore, highly corrosive seawater would directly contact the deposited LbL assembly. The stability of the LbL assembly became one of the key factors to ensure the long term performance of the deposited film. Thus, crosslinking was conducted to improve the stability of the deposited polyelectrolyte film. The reported crosslinking methods for LbL assembly usually need additional chemical treatment,^{[8]} high energy substance irridation,^{[15]} or high temperature (>100° C.)^{[17,20]} Nevertheless, an easily conducted reaction (aminolysis) was used to form amide covalent bonds between the ester group of P1 and the amino group of PEI as shown in FIG. 2. The aminolysis reaction is a nucleophilic substitution. The secondary amino groups of PEI with higher nucleophilicity than the primary amino groups would be easier to react with ester groups.^{[21]} Moreover, the produced methanol is highly evaporative and can be directly removed by vacuum, which could effectively shift the reaction equilibrium to the right hand side and accelerate the reaction.

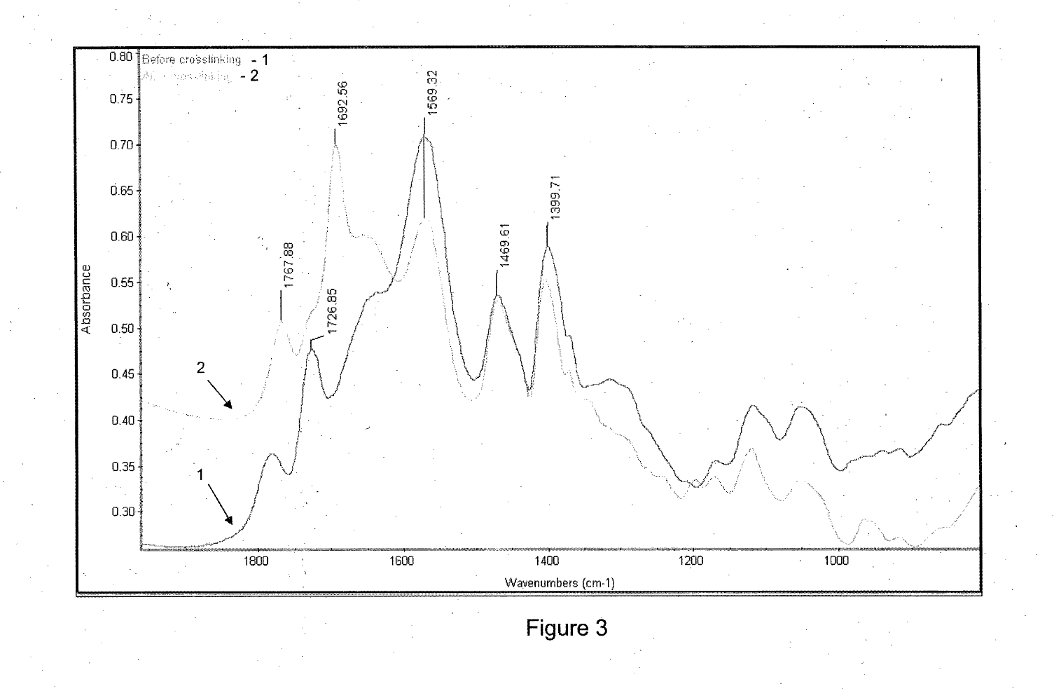

Cross-linking was carried out by exposing of the film to temperature of 60° C. and applying vacuum. The amidation reaction among the polyelectrolyte multilayers was verified by FTIR and XPS spectra of the LbL film before and after annealing. As shown in FIG. 3, before annealing there was a peak at 1726.85 cm⁻¹ belonging to C═O of ester. After annealing, the peak at 1726.85 cm⁻¹ disappeared and a new peak at 1692.56 cm⁻¹ belonging to C═O of amide showed up, indicating the aminolysis of P1's ester group by amino group from PEI to form amide bond.

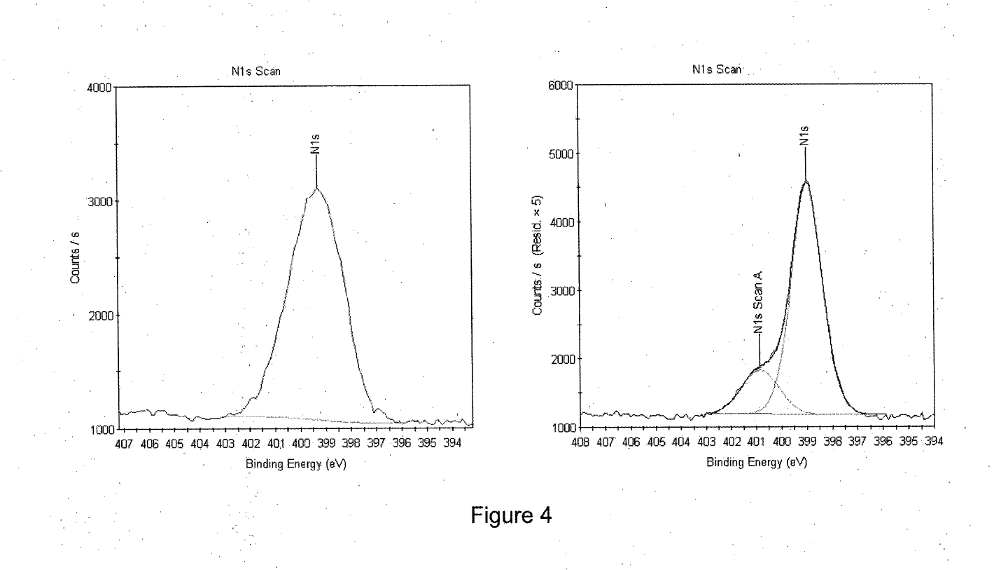

The XPS spectra of the LbL films were also scanned before and after annealing to verify the crosslinking reaction. In the amidation reaction, the binding energy of C, O and N atoms would be changed. However, C and O atoms were covalently connected with other atoms to form several functional groups, resulting complex and unanalyzable XPS spectra. The change of N atom spectra before and after crosslinking was clearer as shown in FIG. 4. Only 1 peak shown up at 399.3 eV indicated the existence of amino groups connecting to the carbon chain.^{[22]} After annealing, besides the peak at around 399 eV, a new peak showed up at 400.87 eV belongs to N atom connecting to C═O group.^{[23]} The increase of binding energy indicates that more energy was needed to motivate the electron from the N 1 s orbit or lower electron density of the N atom. It means the electron of N atom was attracted by the O atom after amidation. In other words, a part of amino groups were reacted to form amide bond, which is in accordance with the deduction of the above results.

The absence of ester v_{C═O} signal from FTIR of cross-linked film and the fact that there is a large excess of amine groups from PEI compared to P1 ester groups at the polymer interphase within the LbL structure, together suggest that the amidation reaction yield is close to quantitative.

### Morphology and Thickness of the Deposited LbL Films

The high control over the thickness of films, constructed with LbL technique, is a great advantage for many applications. It is particularly important when surface chemistry modification is combined with other antifouling strategies, such as surface topological patterning, where thickness control is essential to prevent overcoating of patterned features.

The thickness of the built up LbL films were measured by AFM. The step AFM measurement is a direct and accurate method to detect the multilayer thickness because the AFM tips would directly contact the bare substrate surface and the multilayer surface, and then calculate the height difference to give the thickness.

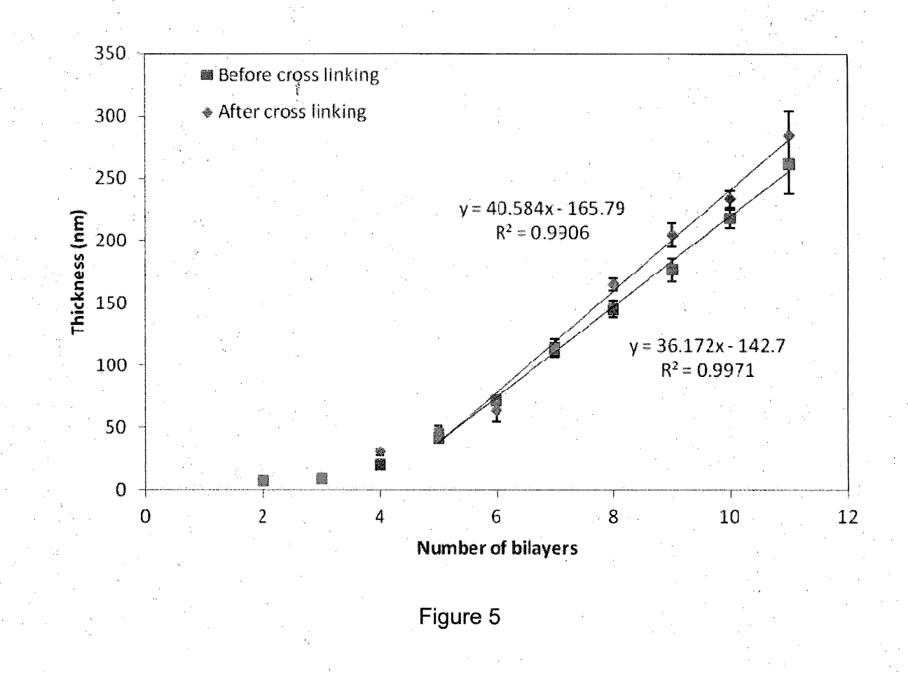

The polyelectrolyte multilayer build up usually becomes linear after the first few layers.^{[23]} The thickness of LbL film became controllable only after the buildup of the adjacent zone to the substrate and the adjacent zone to the film/solution or film/air interface.^{[13]} Similarly, the thickness of the polyelectrolyte multilayers in this study grew linearly after the formation of initial 5 bilayers as shown in FIG. 5. In addition, the thicknesses of the LbL films before crosslinking were also measured. Due to the mild crosslinking condition, only a slight thickness increase was observed after crosslinking.

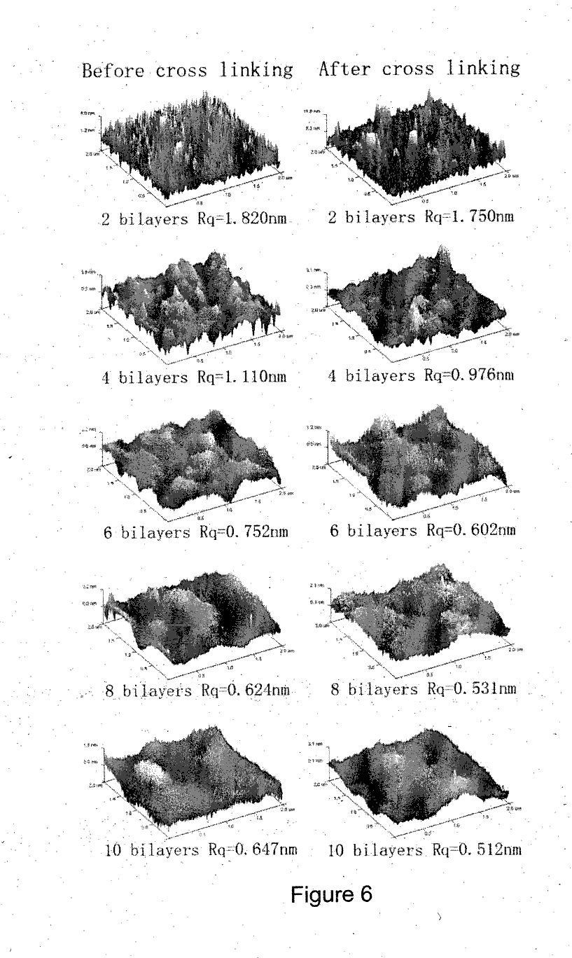

In order to investigate the morphology of the LbL film with different bilayers before and after crosslinking, AFM images of these LbL films were scanned (see FIG. 6). The surface roughness of the LbL film slightly decreased with the number of bilayers. In addition, the roughness of the LbL film was very low (˜0.6 nm) and was not changed a lot by more polyelectrolyte deposition after 6 bilayers. It seems the deposition of polyelectrolytes might smooth the substrate surface under the premise that the initial roughness is not very high. On the other hand, the roughnesses of the LbL assemblies were slightly decreased by the crosslinking procedure.

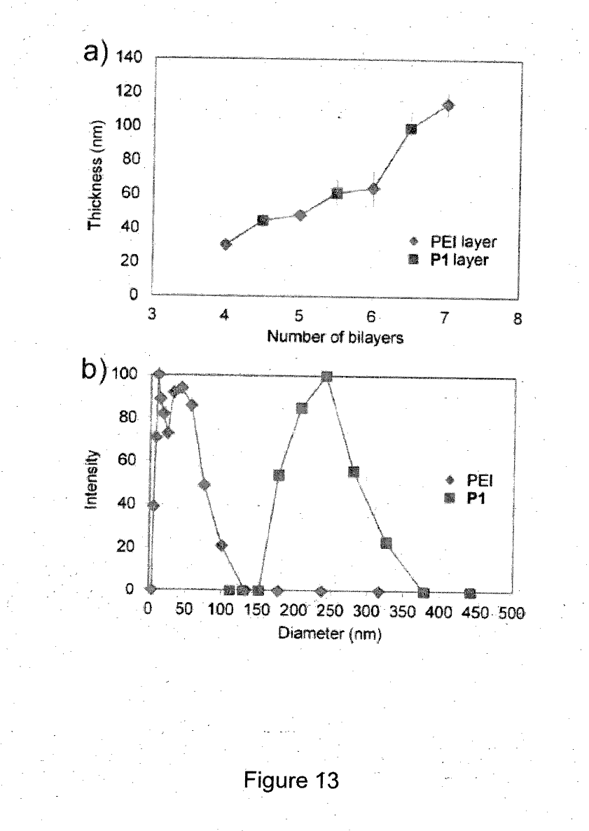

The micelle sizes of the polyelectrolytes in water solution were measured with DLS, using the same concentrations as for the film deposition. The observable mean diameter of micelles for the PEI solution was much smaller (30 nm) than for the P1 solution (216 nm). This size variation was also reflected in the bilayer structure, the single layer built up by PEI was thinner than P1 (FIG. 13).

The thickness of the LbL films could be controlled by adjusting the number of layers deposited. As mentioned, the deposition of the polyelectrolyte multilayers resulted in a slightly smoother substrate surface (see also roughness data in FIG. 6). This is desirable since a smoother surface can reduce the adhesion of microorganisms such as bacteria in the first stage of biofouling. The mild cross-linking conditions and moderate cross-linking density did not affect the film thickness and film morphology and the resulting layers exhibited smooth and continuous structures.

In short, the thickness of the deposited LbL film was highly controllable. The deposition of the polyelectrolyte multilayers may slightly smooth the substrate surface. This is desirable because a smoother surface can reduce the adhesion of proteins and microorganisms such as bacteria in the first stage of biofouling. On the other hand, the designed patterns or structures will not be affected by the LbL deposition. In addition, both the thickness and the topography of the deposited LbL assembly were not obviously affected by the crosslinking.

### Stability of the LbL Deposited Films

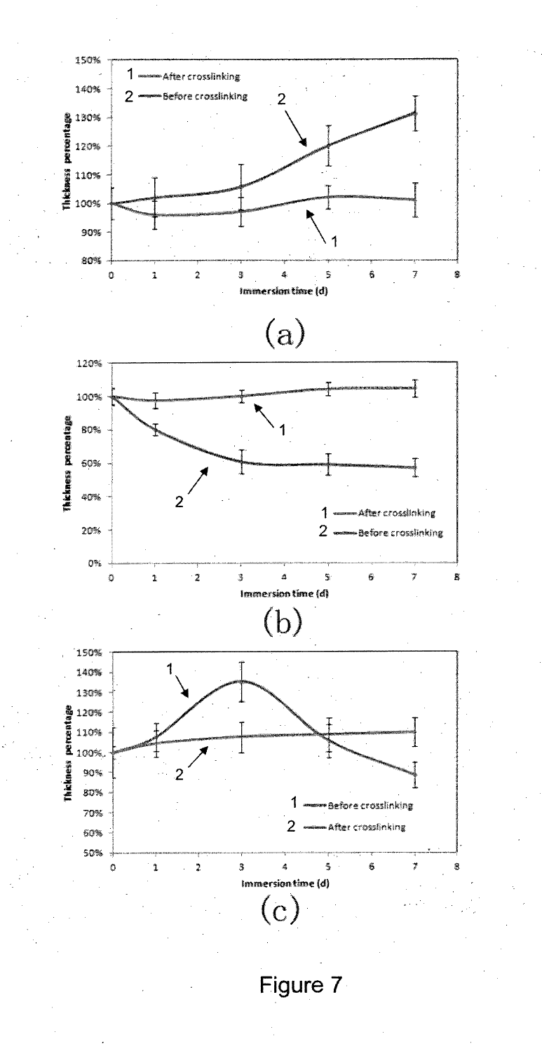

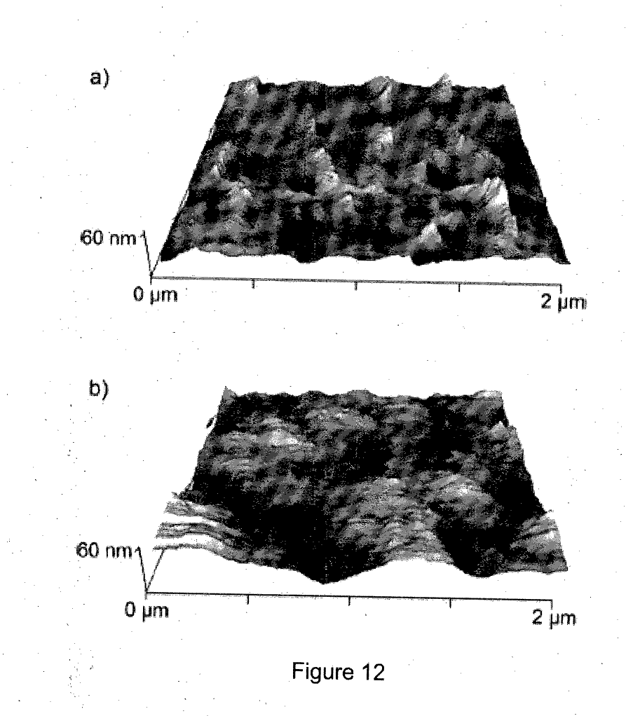

The connection among the deposited polyelectrolyte multilayers without crosslinking was electrostatic interaction or ionic bonds. The stability of the LbL assembly only with electrostatic interaction can be dramatically affected by the environmental conditions such as ionic strength, solvent, pH value, etc. Especially, in a marine environment, a more stable LbL assembly that could resist the corrosion of seawater and the dissolution of some special solvents is particularly important for it to achieve long term performance. In the assemblies and methods of the present invention, crosslinking, strong covalent bonds were built up among the polyelectrolyte multilayers. The stabilities of the prepared LbL films were evaluated by artificial seawater, DMSO and real seawater immersion tests. As shown in FIG. 7(a), the LbL film without crosslinking gradually swelled about 30% after 7 d artificial seawater immersion. However, the thickness of the crosslinked LbL film almost maintained at the initial value during 7 d artificial seawater immersion test. A certain concentration of salt could penetrate into the LbL film then presumably some of the internal ionic bonds open up, causing LbL film swelling.^{[24]} In addition, the LbL films were also immersed in real seawater for 7 d. Molecular level swelling was also clearly visible by AFM in the liquid environment (FIG. 12). The roughness value of the LbL film with cross-linking was close to that without cross-linking in dry condition. After exposure to ASW the films swell and their roughness value increases. The swelling behavior and observed roughness changes were different in cross-linked and noncross-linked film. As shown in FIG. 12, after five days of immersion in ASW, the LbL film without cross-linking achieved roughness values of R_{q}=13.04 nm compared to R_{q}=6.58 nm of cross-linked polymer. Since a certain amount of salt could penetrate into the LbL film, one may assume that some of the internal ionic bonds could open up, causing the LbL film to swell. After swelling, the LbL films became rougher, weaker and prone to erosion by corrosive chemicals or microorganisms in the marine environment. This was confirmed in experiments conducted in the sea (raft test, FIG. 7c).

As shown in FIG. 7(c), the thickness of uncrosslinked LbL film was increasing in the first 3 d, indicating swelling, but decreasing after 3 d. It is highly possible that after swelling, the uncrosslinked LbL film started to dissolve in real seawater which is much more corrosive than the artificial seawater because of more complex composition, harsher environment and existence of microorganisms. By contrast, the crosslinked LbL film only swelled a little during 7 d real seawater immersion. On the other hand, the thickness of the LbL film without crosslinking dropped almost to 60% after 3 d immersion in DMSO. In contrast, no obvious change of the crosslinked LbL film thickness was observed during the 7 d DMSO immersion test. When the LbL film was immersed in DMSO, the polymer-solvent interaction is higher than the polymer-polymer electrostatic attraction, as a result, the deposited polyelectrolytes were dissolved rather than aggregated in solid state. However, the formed covalent bonds by crosslinking effectively enhanced the interaction among the deposited multilayers and prevented the swelling and dissolution of the crosslinked LbL film by seawater and DMSO, respectively.

In short, the covalently cross-linked LbL film exhibited enhanced stability in artificial seawater, under field conditions in natural seawater, and in DMSO.

### Antifouling Performance of the LbL Deposited Film Against Amphora and Cyprids

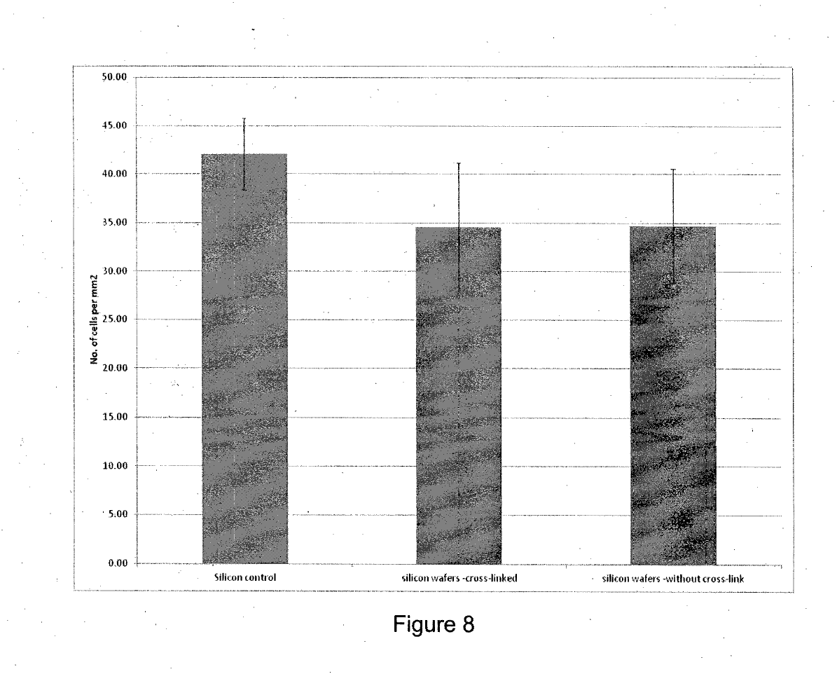

Marine fouling is a serious problem of maritime industries. The control the settlement and reproduction of organisms is one of the key strategies to prevent marine fouling. In general, microalgal slimes occur in the early stages before the settlement of macrofouling iunvertebrates. The diatom, Amphora sp., is a common fouling microalgae, and has been used to evaluate the antifouling performance of coatings. As shown in FIG. 8, the silicon surface with the crosslinked or uncrosslinked LbL film exhibited less Amphora attachment than the control silicon surface. It is obvious that the surface with the LbL film provided better antifouling performance than the control silicon surface against amphora. In addition, the crosslinked LbL film and the uncrosslinked LbL film showed similar performances, due to similar antifouling mechanism.

Barnacles are common macrofouling organisms that rapidly colonize immersed man-made objects. They are also suitable for lab scale antifouling tests because larval cyprid of the barnacle will settle readily in static water assays.^{[25]} B. amphitrite is a cosmopolitan species of barnacles that has been widely used in antifouling experiments.^{[26]} The lab scale cyprids incubation test was conducted to evaluate the antifouling performance of the LbL assembly on silicon wafer. Due to similar antifouling performances of the LbL film before and after crosslinking, only the crosslinked LbL film was evaluated in the cypris test.

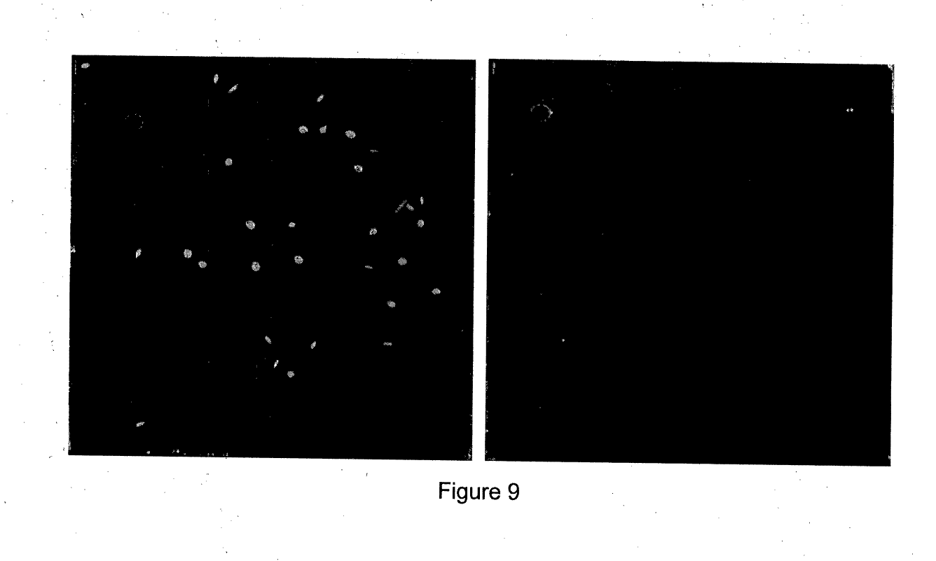

As shown in FIG. 9, a lot of cyprids attached onto the control silicon wafers without coating. In the test described, a total of 119 cyprids was found attached onto the control silicon wafers. However, only very limited amount of cyprids were observed on the silicon wafer surface with the LbL assembly (only 17 in total). It was obvious that the deposited polyelectrolyte multilayers effectively prevented the attachment of cyprids. The deposited polyelectrolyte multilayers contain neutral or equally mixed charged bulk layers and a positively charged top layer. It has been reported that cyprids did not prefer to settle on positively charged surfaces, when they were exploring and sensing the substratum by making physical contact via the antennular pad.^{[27]} This may one of the reasons why the prepared LbL film with positively charged top layer could effectively prevent the attachment of cyprids. On the other hand, the positively charged surface can kill the attached bacteria and then effectively prevent biofilm formation.^{[12, 14]} As a result, macrofoulants preferring to settle on biofilms would be effectively limited.

In addition, the neutral bulk layers are quite similar to zwitterionic materials.^{[13]} It is well known that zwitterionic materials provided promising anti-biofouling performance.^{[28]} It is highly possible the balanced counter-charged bulk layers also contributed to the antifouling performance of the deposited LbL film.

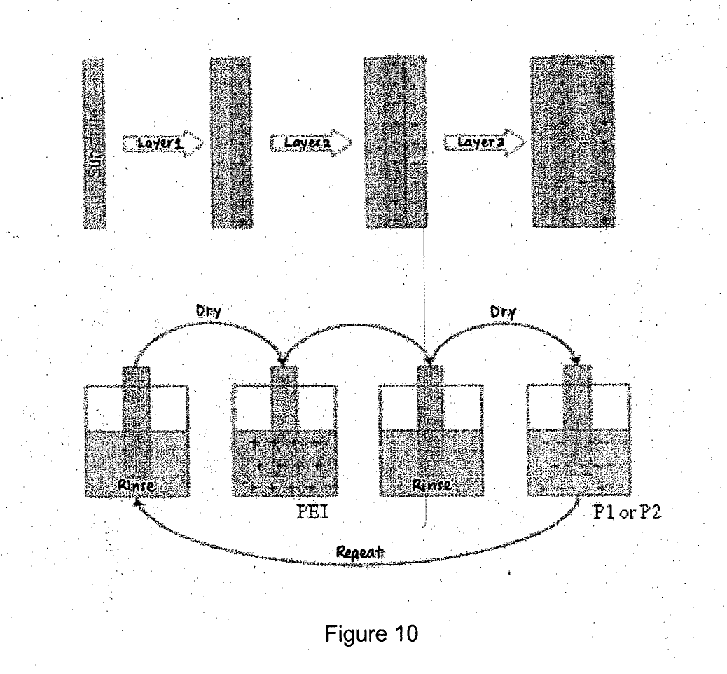

Antifouling mechanism of LbL films (see FIG. 10):
Positively charged top layer:
1. Prevent the attachment of organisms^{[27]}
2. Prevent the formation of biofilm^{[11, 13]}
Zwitterionic like balanced counter-charged bulk layers:
1. Zwitterionic materials provided promising anti-biofouling performance.^{[28]}

In conclusion, in this study, a novel polyanion with easy crosslinking property was synthesized from PIAMA and immobilized onto silicon wafer via LbL polyelectrolyte deposition method to prevent marine fouling. The synthesis of the polyanion was verified by FTIR and 1H NMR. The crosslinking reaction or amidation of the polyanion with PEI was confirmed by FTIR and XPS spectra of the deposited polyelectrolyte multilayers before and after crosslinking. In addition, thickness and morphology of the deposited LbL films before and after crosslinking were also studied with AFM. The thickness growth of the polyelectrolyte multilayers became linear after the first 5 layers. The polyelectrolyte deposition slightly smoothed the substrate surface. The crosslinking process in mild condition did not obviously change the thickness and topography of the deposited LbL films, but dramatically enhanced the stability of them in seawater and solvent (DMSO). Even the uncrosslinked LbL film swelled in seawater and dissolved in DMSO, the crosslinked LbL film almost maintained the initial thickness after seawater or DMSO immersion.

More important, in the antifouling test, the deposited LbL film could effectively inhibit the attachment of marine fouling organisms as represented by Amphora and barnacle cyprids. In short, the stable polyelectrolyte LbL assembly has potential to be used in marine industries to achieve antifouling performance.

LbL assembly is a simple and inexpensive procedure and a wide range of materials with various antifouling properties can be deposited by this method on the substrate. Furthermore, the highly controllable thickness of the LbL film is suitable for various patterned surfaces.

Those skilled in the art will appreciate that the invention described herein is susceptible to variations and modifications other than those specifically described. The invention includes all such variation and modifications. The invention also includes all of the steps, features, formulations and compounds referred to or indicated in the specification, individually or collectively and any and all combinations or any two or more of the steps or features.

Each document, reference, patent application or patent cited in this text is expressly incorporated herein in their entirety by reference, which means that it should be read and considered by the reader as part of this text. That the document, reference, patent application or patent cited in this text is not repeated in this text is merely for reasons of conciseness.

Any manufacturer's instructions, descriptions, product specifications, and product sheets for any products mentioned herein or in any document incorporated by reference herein, are hereby incorporated herein by reference, and may be employed in the practice of the invention. The present invention is not to be limited in scope by any of the specific embodiments described herein. These embodiments are intended for the purpose of exemplification only. Functionally equivalent products, formulations and methods are clearly within the scope of the invention as described herein.

The invention described herein may include one or more range of values (e.g. size, concentration etc). A range of values will be understood to include all values within the range, including the values defining the range, and values adjacent to the range which lead to the same or substantially the same outcome as the values immediately adjacent to that value which defines the boundary to the range.

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. patent law; e.g., they can mean “includes”, “included”, “including”, and the like; and that terms such as “consisting essentially of” and “consists essentially of” have the meaning ascribed to them in U.S. patent law, e.g., they allow for elements not explicitly recited, but exclude elements that are found in the prior art or that affect a basic or novel characteristic of the invention.

Other definitions for selected terms used herein may be found within the detailed description of the invention and apply throughout. Unless otherwise defined, all other scientific and technical terms used herein have the same meaning as commonly understood to one of ordinary skill in the art to which the invention belongs.

The present invention may be further defined and understood by reference to the following numbered paragraphs:

1. A polyanion for fabrication of layer by layer polyelectrolyte assemblies to resist marine biofouling.
2. The polyanion of paragraph 1, which is capable of crosslinking with amine such as polyethylene imine, polyallyl amine or any other amine polycations in a mild condition.
3. The mild condition of paragraph 3, wherein annealing temperature is between 20 to 80° C.
4. The polyanion of paragraph 1 composed of anionic repeating units and carboxylic ester repeating units in ratio from 1000 to 1.
5. The polyanion of paragraph 1 with molecular mass from 5 kD to 10,000 kD.
6. Anionic repeating units of paragraph 4 such as carboxylic, sulfonic and phosphatic groups.
7. Carboxylic esters in repeating units of paragraph 4 obtained from carboxylic acid and alcohols such as alkyl alcohols C1-C10, benzyl alcohol, nitrobenzyl alcohols, and fluoric benzyl alcohols including mono-, bi-, tri-, tetra-, and pentafluorobenzyl alcohols.
8. The polyanion of paragraph 1, wherein grafting of leaving groups is achieved through any esterification method.
9. The polyanion of paragraph 1, wherein grafting of leaving groups is achieved through alcoholysis of anhydride groups to produce ester groups and carboxyl acid groups.
10. The polyanion of paragraph 1, wherein grafting of leaving groups is achieved coupling to carboxylic groups by carbodimide coupling.
11. The polycations of paragraph 2, which contain primary and/or secondary amino groups.
12. The crosslinking reaction of paragraph 2, wherein amide bonds are built up between ester groups and amino groups through aminolysis.
13. A crosslinked layer by layer assembly based on the crosslinking reaction of paragraph 6, which is stable in seawater and solvents.
14. The polyanion of paragraph 1, wherein the backbone has the following generic structure:

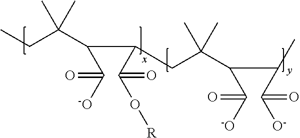

15. The polyanion of paragraph 6, wherein x+y=10 to 10000 and x/y=0 to 1.
16. The polyanion of paragraph 6, wherein R is any small aliphatic group preferably methyl or aromatic group preferably benzyl, nitrobenzyl, mono-, bi-, tri-, tetra-, pentafluorobenzyl, or O-acylisourea, more preferably methyl or aromatic group preferably benzyl, nitrobenzyl, mono-, bi-, tri-, tetra-, or pentafluorobenzyl.
17. A method to prepare crosslinked layer by layer assemblies thereof, using the polymer prepared according to any of paragraphs 1 to 11.

### REFERENCES

A number of publications are cited herein in order more fully to describe and disclose the invention and the state of the art to which the invention pertains. Full citations for these references are provided below. Each of these references is incorporated herein by reference in its entirety into the present disclosure, to the same extent as if each individual reference was specifically and individually indicated to be incorporated by reference.
[1] S. Abarzua, S. Jakubowski, Mar. Ecol. Prog. Ser. 1995, 123, 301.
[2] F. Olivier, R. Tremblay, E. Bourget, D. Rittschof, Mar. Ecol. Prog. Ser. 2000, 199, 185.
[3] I. Woods Hole Oceanographic, S. United States. Navy Dept. Bureau of, in Marine fouling and its prevention, United States Naval Institute, Annapolis, Md., 1952, 1.
[4] M. E. Callow, J. A. Callow, Biologist 2002, 49, 10.
[5] J. F. Schumacher, M. L. Carman, T. G. Estes, A. W. Feinberg, L. H. Wilson, M. E. Callow, J. A. Callow, J. A. Finlay, A. B. Brennan, Biofouling 2007, 23, 55.
[6] E. Lindner, Biofouling 1992, 6, 193.
[7] S. Cao, J. D. Wang, H. S. Chen, D. R. Chen, Chin. Sci. Bull. 2011, 56, 598.
[8] J. F. Schumacher, C. J. Long, M. E. Callow, J. A. Finlay, J. A. Callow, A. B. Brennan, Langmuir 2008, 24, 4931.
[9] J. Verran, R. D. Boyd, Biofouling 2001, 17, 59.
[10] D. M. Yebra, S. Kiil, K: Dam-Johansen, Prog. Org. Coat. 2004, 50, 75.
[11] Y. H. Zhao, X. Y. Zhu, K. H. Wee, R. Bai, J. Phys. Chem. B 2010, 114, 2422.
[12] G. Decher, J. B. Schlenoff, Multilayer thin films: sequential assembly of nanocomposite materials, Wiley-VCH, Weinheim 2003.
[13] J. A. Lichter, M. F. Rubner, Langmuir 2009, 25, 7686.
[14] W. H. Kuo; M. J. Wang, H. W. Chien, T. C. Wei, C. Lee, W. B. Tsai, Biomacromolecules 2011, 12, 4348.
[15] C. Cortez, J. F. Quinn, X. Hao, C. S. Gudipati, M. H. Stenzel, T. P. Davis, F. Caruso, Langmuir 2010, 26, 9720.
[16] X. Cao, M. E. Pettitt, F. Wode, M. P. rpa Sancet, J. Fu, J. Ji, M. E. Callow, J. A. Callow, A. Rosenhahn, M. Grunze, Adv. Funct. Mater. 2010, 20, 1984.
[17] F. Wang, J. Feng, C. Gao, Colloid. Polym. Sci. 2008, 286, 951.
[18] C. J. Lefaux, J. A. Zimberlin, A. V. Dobrynin, P. T. Mather, J, Polym. Sci., Part B: Polym. Phys. 2004, 42, 3654.
[19] E. Pretsch, P. Bnhlmann, C. Affolter, Structure determination of organic compounds, Springer, Berlin; Heidelberg 2009.
[20] W. S. Jang, A. T. Jensen, J. L. Lutkenhaus, Macromolecules 2010, 43, 9473.
[21] F. Brotzel, Verl. Dr. Hut, München 2008.
[22] J. F. Moulder, J. Chastain, Handbook of X-ray photoelectron spectroscopy: a reference book of standard spectra for identification and interpretation of XPS data: Perkin-Elmer Corporation, Eden Prairie, Minn. 1992.
[23] J. B. Schlenoff, S. T. Dubas, Macromolecules 2001, 34, 592.
[24] G. B. Sukhorukov, J. Schmitt, G. Decher, Berichte Der Bunsen-Gesellschaft-Physical Chemistry Chemical Physics 1996, 100, 948.
[25] C. Hellio, C. Simon-Colin, A. S. Clare, E. Deslandes, Biofouling 2004, 20, 139; D. Rittschof, A. S. Clare, D. J. Gerhart, A. Mary, J. Bonaventura, Biofouling 1992, 6, 115.
[26] A. S. Clare, J. T. Hoeg, Biofouling 2008, 24, 55.
[27] L. Petrone, A. Di Fino, N. Aldred, P. Sukkaew, T. Ederth, A. S. Clare, B. Liedberg, Biofouling 2011, 27, 1043.
[28] S. Jiang, Z. Cao, Adv. Mater. 2010, 22, 920; S. Krishnan, C. J. Weinman, C. K. Ober, J. Mater. Chem. 2008, 18, 3405.

1. A layer-by-layer polyelectrolyte assembly on a substrate for resisting marine biofouling, the assembly comprising an anionic polyelectrolyte layer cross-linked by covalent bonds to a cationic polyelectrolyte layer.

2. The layer-by-layer polyelectrolyte assembly of claim 1, wherein the cross-linking is via amide bonds.

3. The layer-by-layer polyelectrolyte assembly of claim 1 or claim 2, wherein the anionic polyelectrolyte comprises units of formula: 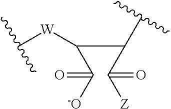
wherein W is optionally substituted C₁₋₄alkylene;
and Z is a bond to the cationic polyelectrolyte.

4. A layer-by-layer polyelectrolyte assembly on a substrate for resisting marine biofouling, the assembly comprising an anionic polyelectrolyte layer and a, cationic polyelectrolyte layer, wherein the cationic polyelectrolyte has substituent groups capable of undergoing a cross-linking nucleophilic substitution reaction with substituent groups of the anionic polyelectrolyte to form cross-linking covalent bonds.

5. The layer-by-layer polyelectrolyte assembly of any preceding claim, wherein the anionic polyelectrolyte comprises anionic repeating groups that are selected from carboxylic, sulfonic and phosphoric acid groups.

6. The layer-by-layer polyelectrolyte assembly of any of claim 1 or claims 3 to 5, wherein the cationic polyelectrolyte is a polyamine bearing —NH₂ and/or —NH— functional groups.

7. An anionic polyelectrolyte for the fabrication of a polyelectrolyte layer-by-layer assembly for resisting marine biofouling, the anionic polyelectrolyte comprising repeating anionic groups selected from carboxylic acid groups, sulphonic acid groups and phosphoric acid groups, and repeating crosslinking leaving groups, optionally wherein the repeating anionic groups are carboxylic acid groups.

8. A method of fabrication of a layer-by-layer polyelectrolyte assembly, the method comprising:
a) depositing a layer of anionic polyelectrolyte or cationic polyelectrolyte onto a substrate;
b) depositing a layer of either:
(i) where the layer in (a) was anionic polyelectrolyte, a layer of cationic polyelectrolyte, or
(ii) where the layer in (a) was cationic polyelectrolyte, a layer of anionic polyelectrolyte;
wherein the cationic polyelectrolyte has substituent groups capable of undergoing a cross-linking nucleophilic substitution with substituent groups of the anionic polyelectrolyte to form cross-linking covalent bonds;
c) subjecting said layer-by-layer assembly to conditions to facilitate the formation of cross-linking covalent bonds between the layers.

9. The method of claim 8, wherein the cross-linking covalent bonds are amide bonds.

10. The anionic polyelectrolyte of claim 7, or the method of claim 8 or claim 9, wherein the anionic polyelectrolyte comprises units “A” and units “B”, wherein each unit A bears one or more carboxylic acid group, sulphonic acid group or phosphonic acid, and wherein each unit B bears a substituent group capable of undergoing a cross-linking nucleophilic substitution reaction.

11. The anionic polyelectrolyte of claim 10, or the method of claim 10, wherein the substituent group capable of undergoing a cross-linking nucleophilic substitution reaction is an activated carboxylic acid group.

12. The anionic polyelectrolyte of claim 11, or the method of claim 11, wherein the activated carboxylic acid group is an acyl halide or an ester.

13. The anionic polyelectrolyte of claim 11, or the method of claim 11, wherein the activated carboxylic acid group is an alkyl ester, optionally methyl or ethyl ester.

14. The anionic polyelectrolyte of claim 10, or the method of claim 10, wherein unit B has the formula: 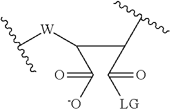
wherein W is optionally substituted C₁₋₄alkylene;
and LG is a leaving group.

15. The anionic polyelectrolyte of claim 14, or the method of claim 14, wherein LG is OR³, wherein R³ is a small aliphatic group, preferably methyl; a C₆-aryl-CH₂ group, preferably benzyl, nitrobenzyl, mono-, bi-, tri-, tetra-, or pentafluorobenzyl; or pentafluorophenyl; or LG is halo, imidazole or a suitably activated carboxylic acid.

16. The anionic polyelectrolyte of claim 7, or the method of claim 8 or claim 9, wherein the anionic polyelectrolyte has a backbone of generic structure: 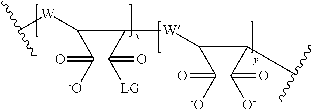
wherein x+y=10 to 10000 and 0<x/y≧1;
W and W′ are independently optionally substituted C₁₋₄alkylene; and
LG is a leaving group.

17. The method of any of claims 8 to 16, the method further comprising the step of obtaining the anionic polyelectrolyte from a corresponding cyclic anhydride by alcoholysis, optionally by methanolysis.

18. A method of preparing an anionic polyelectrolyte according to any one of claims 10 to 16, the method comprising the step of obtaining the anionic polyelectrolyte from a corresponding cyclic anhydride by alcoholysis, optionally by methanolysis.

19. The method of claim 17 or claim 18, wherein the cyclic anhydride is poly(isobutylene-alt-maleic anhydride).

20. The polyelectrolyte layer-by-layer assembly of any one of claims 1 to 6 or the method of any one of claims 8 to 16, wherein the cationic polyelectrolyte is polyethylenimine.

21. Use of an anionic polyelectrolyte according to any one of claims 10 to 16 in a method of manufacture of a polyelectrolyte layer-by-layer assembly for resisting marine biofouling.

22. Use of poly(isobutylene-alt-maleic anhydride) in a method of manufacture of a polyelectrolyte layer-by-layer assembly for resisting marine biofouling.

23. An aqueous composition comprising an anionic polyelectrolyte according to any one of claims 10 to 16.
